(19) United States
(12) Patent Application Publication
(10) Pub. No.: US 2023/0069953 A1
(43) Pub. Date: Mar. 9, 2023

(54) LEARNED DOWNSAMPLING BASED CNN FILTER FOR IMAGE AND VIDEO CODING USING LEARNED DOWNSAMPLING FEATURE

(71) Applicant: HUAWEI TECHNOLOGIES CO., LTD., Shenzhen (CN)

(72) Inventors: Hu Chen, Munich (DE); Lars Hertel, Luebeck (DE); Erhardt Barth, Luebeck (DE); Thomas Martinetz, Luebeck (DE); Elena Alexandrovna Alshina, Munich (DE); Anand Meher Kotra, Munich (DE); Nicola GIULIANI, Munich (DE)

(21) Appl. No.: 17/987,676

(22) Filed: Nov. 15, 2022

Related U.S. Application Data
(63) Continuation of application No. PCT/EP2021/060210, filed on Apr. 20, 2021.

(30) Foreign Application Priority Data
May 15, 2022 (EP) PCT/EP2020/063630

(51) Int. Cl. G06T 5/00; G06T 3/40; G06N 3/08; G06N 3/04

(52) U.S. Cl. CPC G06T 5/006; G06T 3/4046; G06N 3/08; G06N 3/0481

(57) ABSTRACT

A method and apparatus are provided for processing with a trained neural network, and for training of such neural network for image modification, which relate to image processing and in particular to modification of an image using the processing such as the neural network. The processing is performed to generate an output image. The output image is generated by processing the input image with the neural network. The processing with the neural network includes at least one stage including image down-sampling and filtering of the down-sampled image and at least one stage of image up-sampling. The image down-sampling is performed by applying a strided convolution. According to the application, efficiency of the neural network is increased, which may lead to faster learning and improved performance.

### CROSS-REFERENCE TO RELATED APPLICATIONS

This application is a continuation of International Application No. PCT/EP2021/060210, filed on Apr. 20, 2021, which claims priority to International Patent Application No. PCT/EP2020/063630, filed on May 15, 2020. The disclosures of the aforementioned applications are hereby incorporated by reference in their entireties.

### TECHNICAL FIELD

Embodiments of the present disclosure generally relate to the field of picture processing and more particularly to neural networks based filtering for image and video coding.

### BACKGROUND

Video coding (video encoding and decoding) is used in a wide range of digital video applications, for example broadcast digital TV, video transmission over internet and mobile networks, real-time conversational applications such as video chat, video conferencing, DVD and Blu-ray discs, video content acquisition and editing systems, and camcorders of security applications.

The amount of video data needed to depict even a relatively short video can be substantial, which may result in difficulties when the data is to be streamed or otherwise communicated across a communications network with limited bandwidth capacity. Thus, video data is generally compressed before being communicated across modern day telecommunication networks. The size of a video could also be an issue when the video is stored on a storage device because memory resources may be limited. Video compression devices often use software and/or hardware at the source to code the video data prior to transmission or storage, thereby decreasing the quantity of data needed to represent digital video images. The compressed data is then received at the destination by a video decompression device that decodes the video data. With limited network resources and ever increasing demands of higher video quality, improved compression and decompression techniques that improve compression ratio with little to no sacrifice in picture quality are desirable.

In general, image compression may be lossless or lossy. In lossless image compression, the original image can be perfectly reconstructed from the compressed image. However, the compression rates are rather low. In contrast, lossy image compression allows high compression rates with downside of not being able to perfectly reconstruct the original image. Especially when used at low bit rates, lossy image compression introduces visible spatial compression artifacts.

### SUMMARY

The present invention relates to methods and apparatuses for image modification such as image enhancement or other types of modification.

The invention is defined by the scope of independent claims. Some of the advantageous embodiments are provided in the dependent claims.

In particular, embodiments of the present invention provide an efficient way of image modification by employing features of machine learning.

As mentioned above, the techniques described with reference to FIG. 6 may be also applied separately. For example, the strided convolution also provides benefit, when applied to a neural network of FIG. 2, without being combined with one or more modifications shown in FIG. 6. Correspondingly, a method is provided for modifying an input image, comprising generating an output image by processing the input image with a neural network, wherein the processing with the neural network includes at least one stage including image down-sampling and filtering of the down-sampled image; and at least one stage of image up-sampling, wherein, the image down-sampling is performed by applying a strided convolution.

The strided convolution provides an advantage of reduced complexity. In an exemplary embodiment, the strided convolution has a stride of 2. This value represents a good tradeoff between the complexity and the quality of downsampling.

According to an exemplary implementation, the neural network is based on a U-net, and wherein for establishing the neural network, the U-net is modified by introducing a skip connection to such U-net, the skip connection is adapted to connect the input image with the output image.

For example, the neural network is parametrized according to a value of a parameter indicative of an amount or type of distortion of the input image. Alternatively, or in addition, the activation function of the neural network is a leaky rectified linear unit activation function.

In order to further maintain the image size unaffected by the image boundaries with unavailable pixels, the image down-sampling is performed by applying padded convolution.

In some embodiments, the output image is a correction image, and the method further comprises modifying the input image by combining the input image with the correction image.

For instance, the correction image and the input image have the same vertical and horizontal dimensions, and the correction image is a difference image and the combining is performed by addition of the difference image to the input image.

According to an embodiment, a method is provided for reconstructing an encoded image from a bitstream, the method including: decoding the encoded image from the bitstream, and applying the method for modifying an input image as described in the present disclosure with the input image being the decoded image.

According to an aspect, a method is provided for reconstructing a compressed image of a video, comprising: reconstructing an image using an image prediction based on a reference image stored in a memory, applying the method for modifying an input image as mentioned above with the input image being the reconstructed image, and storing the modify image into the memory as a reference image.

According to an aspect, a method is provided for training a neural network for modifying a distorted image, the method comprising: inputting to the neural network pairs of a distorted image as a target input and a target output image which is based on an original image, wherein processing with the neural network includes at least one stage including an image down-sampling and a filtering of the down-sampled image; and at least one stage of an image up-sampling, wherein the image down-sampling is performed by applying a strided convolution, and adapting at least one parameter of the filtering based on the inputted pairs:

In particular, the adapting of the at least one parameter of the filtering is based on a loss function corresponding to Mean Squared Error (MSE).

Alternatively or in addition, the adapting of the at least one parameter of the filtering is based on a loss function including a weighted average of squared errors for more than one color channels.

According to an aspect, device is provided for modifying an input image, comprising a processing unit configured to generate an output image by processing the input image with a neural network, wherein the processing with the neural network includes at least one stage including image down-sampling and filtering of the down-sampled image; and at least one stage of image up-sampling, wherein the image down-sampling is performed by applying a strided convolution.

According to an aspect, a device is provided for reconstructing an encoded image from a bitstream, comprising: a decoder unit configured to decode the encoded image from the bitstream, and the device configured to modify the decoded image as described above.

According to an aspect, a device is provided for reconstructing a compressed image of a video, comprising: a reconstruction unit configured to reconstruct an image using an image prediction based on a reference image stored in a memory, the device configured to modify the decoded image as described above, and a memory unit storing the modified image as a reference image.

According to an aspect, a device is provided for training a neural network for modifying a distorted image, comprising: a training input unit configured to input to the neural network pairs of a distorted image as a target input and an original image as a target output, a processing unit configured to process with the neural network, wherein processing with the neural network includes at least one stage including an image down-sampling and a filtering of the down-sampled image; and at least one stage of an image up-sampling, wherein the image down-sampling is performed by applying a strided convolution, and an adaption unit configured to adapt at least one parameter of the filtering based on the inputted pairs. Moreover, methods corresponding to the steps performed by the processing circuitry as described above, are also provided.

According to an aspect, a computer product is provided comprising a program code for performing the method mentioned above. The computer product may be provided on a non-transitory medium and include instructions which when executed on one or more processors perform the steps on the method.

The above mentioned apparatuses may be embodied on an integrated chip.

Any of the above mentioned embodiments and exemplary implementations may be combined.

### BRIEF DESCRIPTION OF THE DRAWINGS

In the following embodiments of the invention are described in more detail with reference to the attached figures and drawings, in which

FIG. 1 is an exemplary flow chart illustrating a method for modifying image;

FIG. 2 is a schematic drawing illustrating a general machine learning system following an U-shape;

FIG. 3 is a schematic drawing illustrating a specific exemplary U-net-like structure;

FIG. 4 is a schematic drawing illustrating a known application of an U-net to image segmentation;

FIG. 5 is a schematic drawing illustrating a combination of an input image with a correction image yielding the modified image;

FIG. 6 is a schematic drawing illustrating a specific exemplary U-net-like structure with a global skip connection;

FIG. 7 is a schematic drawing illustrating some types of connections in processing with a neural network;

FIG. 8 is a schematic drawing illustrating a strided max pool operation;

FIG. 9A is a schematic drawing illustrating a non-strided convolution with stride equal to one;

FIG. 9B is a schematic drawing illustrating a strided convolution with stride equal to two;

FIG. 10 is a schematic drawing illustrating a padded convolution;

FIG. 11 is a block diagram diagram illustrating an exemplary device for modification of images;

FIG. 12 is a block diagram showing an example of a video coding system configured to implement embodiments of the invention;

FIG. 13 is a block diagram showing another example of a video coding system configured to implement embodiments of the invention;

FIG. 14 is a block diagram showing an example of a video encoder configured to implement embodiments of the invention;

FIG. 15 is a block diagram showing an example structure of a video decoder configured to implement embodiments of the invention;

FIG. 16 is a block diagram illustrating a decoding device applying the image modification as a post-filter;

FIG. 17 is a block diagram illustrating a decoding device applying the image modification as a loop filter;

FIG. 18 is a block diagram illustrating a training apparatus for training the neural network;

FIG. 19 is a block diagram illustrating an example of an encoding apparatus or a decoding apparatus;

FIG. 20 is a block diagram illustrating another example of an encoding apparatus or a decoding apparatus.

### DETAILED DESCRIPTION OF THE EMBODIMENTS

In the following description, reference is made to the accompanying figures, which form part of the disclosure, and which show, by way of illustration, specific aspects of embodiments of the invention or specific aspects in which embodiments of the present invention may be used. It is understood that embodiments of the invention may be used in other aspects and comprise structural or logical changes not depicted in the figures. The following detailed description, therefore, is not to be taken in a limiting sense, and the scope of the present invention is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

Video coding typically refers to the processing of a sequence of pictures, which form the video or video sequence. Instead of the term “picture” the term “frame” or “image” may be used as synonyms in the field of video coding. Video coding (or coding in general) comprises two parts video encoding and video decoding. Video encoding is performed at the source side, typically comprising processing (e.g. by compression) the original video pictures to reduce the amount of data required for representing the video pictures (for more efficient storage and/or transmission). Video decoding is performed at the destination side and typically comprises the inverse processing compared to the encoder to reconstruct the video pictures. Embodiments referring to “coding” of video pictures (or pictures in general) shall be understood to relate to “encoding” or “decoding” of video pictures or respective video sequences. The combination of the encoding part and the decoding part is also referred to as CODEC (Coding and Decoding).

In case of lossless video coding, the original video pictures can be reconstructed, i.e. the reconstructed video pictures have the same quality as the original video pictures (assuming no transmission loss or other data loss during storage or transmission). In case of lossy video coding, further compression, e.g. by quantization, is performed, to reduce the amount of data representing the video pictures, which cannot be completely reconstructed at the decoder, i.e. the quality of the reconstructed video pictures is lower or worse compared to the quality of the original video pictures.

Several video coding standards belong to the group of “lossy hybrid video codecs” (i.e. combine spatial and temporal prediction in the sample domain and 2D transform coding for applying quantization in the transform domain). Each picture of a video sequence is typically partitioned into a set of non-overlapping blocks and the coding is typically performed on a block level. In other words, at the encoder the video is typically processed, i.e. encoded, on a block (video block) level, e.g. using spatial (intra picture) prediction and/or temporal (inter picture) prediction to generate a prediction block, subtracting the prediction block from the current block (block currently processed/to be processed) to obtain a residual block, transforming the residual block and quantizing the residual block in the transform domain to reduce the amount of data to be transmitted (compression), whereas at the decoder the inverse processing compared to the encoder is applied to the encoded or compressed block to reconstruct the current block for representation. Furthermore, the encoder duplicates the decoder processing loop such that both will generate identical predictions (e.g. intra- and inter predictions) and/or re-constructions for processing, i.e. coding, the subsequent blocks.

To date, a multitude of image compression codecs exist. For convenience of description, embodiments of the invention are described herein, for example, by reference to current state-of-the-art image codecs. The current state-of-the-art image codec is Better Portable Graphics (BPG), which is based on the intra-frame encoding of the video compression standard High Efficiency Video Coding (HEVC, H.265). BPG has been proposed as a replacement for the Joint Photographic Experts Group (JPEG) standard as a more compression-efficient alternative in terms of image quality and file size. One of ordinary skill in the art will understand that embodiments of the invention are not limited to these standards.

However, since lossy image compression allows high compression rates, the disadvantage of all compression codecs are visible spatial compression artifacts. Some exemplary compression artifacts for the BPG image codec may be blocking, blurring, ringing, staircase or basis pattern. However, more kinds of artefacts can occur and the present disclosure is not limited to the above mentioned artefacts.

In recent years, neural networks have gained attention leading to proposals to employ them in image processing. In particular, Convolutional Neural Networks (CNNs) have been employed in such applications. One possibility is to replace the compression pipeline by neural networks entirely. The image compression is then learned by a CNN end-to-end. Multiple publications for this approach were proposed in the literature. While especially structural compression artifacts are greatly reduced in learned image compression, only recent publications exhibit compression rates that are as good as BPG.

Another possibility to reduce these compression artifacts is to apply a filter after the compression. Simple in-loop filters already exist in the HEVC compression standard. More complex filters, especially filters based on Convolutional Neural Networks (CNNs), have been proposed in the literature. However, the visual quality improvement is only limited.

A neural network is a signal processing model which supports machine learning and which is modelled after a human brain, including multiple interconnected neurons. In neural network implementations, the signal at a connection between two neurons is a number, and the output of each neuron is computed by some non-linear function of the sum of its weighted inputs. The connections are called edges. Neurons and edges typically have a weight that adjusts as learning proceeds. The weight increases or decreases the strength of the signal at a connection. The non-linear function of the weighted sum is also referred to as “activation function” or a “transfer function of a neuron”. In some simple implementations, the output may be binary, depending on whether or not the weighted sum exceeds some threshold, corresponding to a step function as the non-linear activation function. In other implementations, a other activation functions may be used, such as a sigmoid or the like. Typically, neurons are aggregated into layers. Different layers may perform different transformations of their inputs. Signals travel from the first layer (the input layer), to the last layer (the output layer), possibly after traversing multiple layers. The weights are learned by training which may be performed by supervised or unsupervised learning. It is noted that the above-described model is only a general model. For specific applications, a neural network may have different processing stages which may correspond to CNN layers and which are adapted to the desired input such as an image or the like.

CNNs are a subclass of neural networks that use shared weights to reduce the number of trainable parameters. They are most commonly applied to visual images.

In some embodiments of the present application, a deep convolutional neural network (CNN) is trained to reduce compression artifacts and enhance the visual quality of the image while maintaining the high compression rate.

In particular, according to an embodiment, a method is provided for modifying an input image. Here, modifying refers to any modification such as modifications obtained typically by filtering or other image enhancement approaches. The type of modification may depend on a particular application. The method includes a step of generating an output image. The generating of the output image is done by processing the input image with a neural network. The processing with the neural network includes at least one stage with image down-sampling and filtering of the down-sampled image; and at least one stage of image up-sampling. In particular, the image down-sampling is performed by applying a strided convolution. Application of the strided convolution may provide advantage of efficient learning as well as processing, e.g. less computationally complex and thus possibly faster. Some particular examples of strided convolution applications are provided below.

It is noted that the method may generate, as an output image, a correction image. The method may then further include a step of modifying the input image by combining the input image with the correction image. The term “correction image” herein refers to an image, which is other than the input image, and which is used for modifying the input image. However, the present disclosure is not limited to modification of the input image by combination with a correction image. Rather, the modification may be performed by processing the input image directly by the network. In other words, the network may be trained to output a modified input image rather than the correction image.

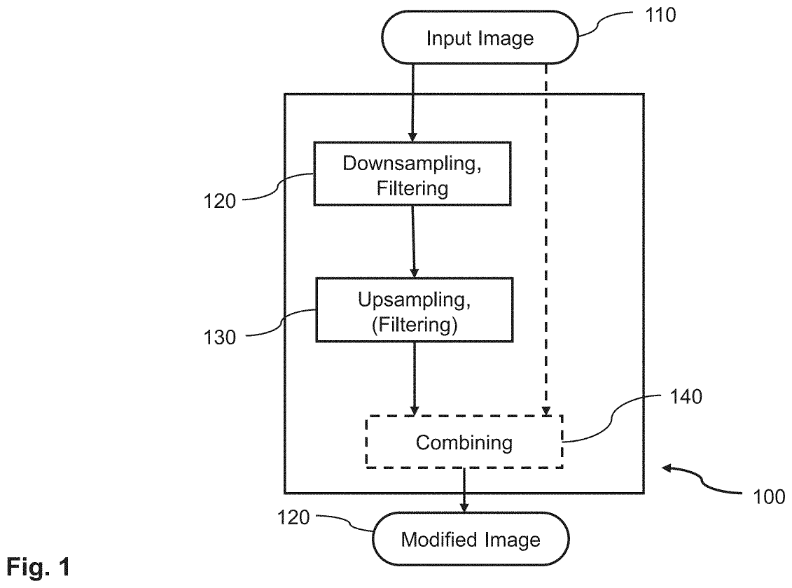

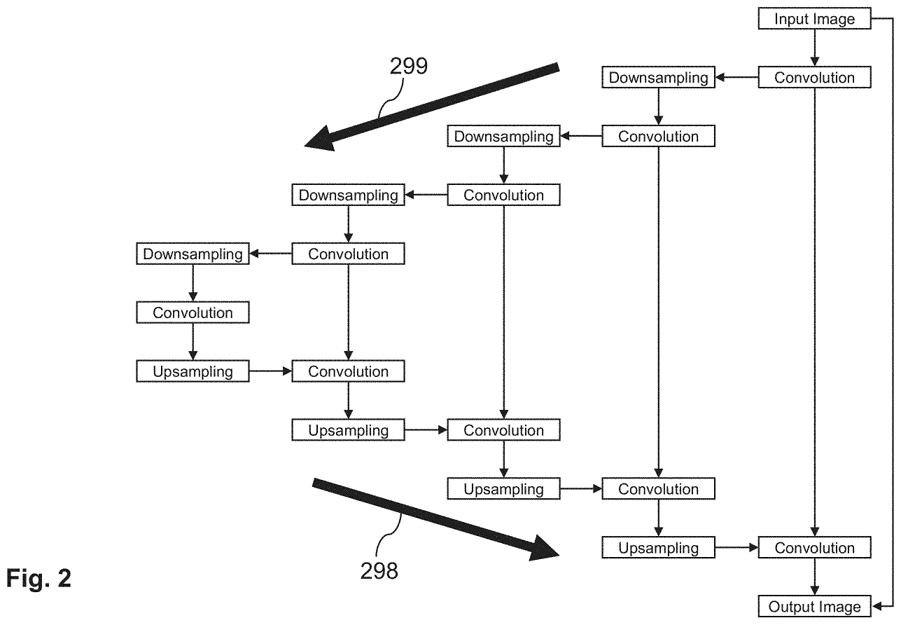

Examples for methods 100 according to the embodiment applying a correction image for modification are shown in FIGS. 1 and 2.

The downsampling and filtering 120 may be a contracting path 299 and the upsampling and filtering 130 may be an expansive path 298 of the neural network (also referred to as “neural net”, or “network”). A contracting path is a convolutional network that may consist of repeated application of convolutions, each followed by an activation function and a downsampling of the image.

A method according to the present embodiment may use at least one convolution stage and at least one activation function stage in the downsampling and in the upsampling respectively. During the contraction, the spatial information is reduced while feature information is increased. The expansive pathway combines the feature and spatial information through a sequence of up-convolutions and concatenations with high-resolution features from the contracting path.

The activation function may be, for instance, a rectified linear unit (ReLU). The ReLU is zero for all negative numbers and a linear function (ramp) for the positive numbers. However, the present disclosure is not limited thereto—different activation functions such as sigmoid or step function, or the like may be used in general. A ReLU function comes close to sigmoid with its shape, but is less complex.

In general, downsampling may be performed in many different ways. For example, every second row and/or every second line of the image may be discarded. Alternatively, the max pooling operation may be applied, which replaces x samples with a sample among the x samples which has the maximum value. Another possibility is to replace x samples with a sample having a value equal to the average of the x samples. The present disclosure is not limited to any particular approach and other types of downsampling are also possible. Nevertheless, as mentioned above, performing the downsampling by strided convolution may provide advantages for both learning phase and processing phase.

Combining 140 the input image 110 with the correction image may lead to a more efficient use of the neural network as the correction image does not have to resemble the complete modified image. This may be especially advantageous in combination with the above described downsampling and upsampling. However, as mentioned above, the combining 140 is optional, and the modified image may be obtained directly by the processing through the network. The network of FIG. 2 may be employed.

The input image 110 may be a video frame or a still image. Modifying may include reducing compression artifacts, artifacts caused by storage/channel errors, or any other defects in images or videos and improving the perceived quality of the image. This may also include reducing defects or improving the quality of a digitized image or video frame, e.g. images or videos recorded or stored in an inferior quality. Improvements may further include coloring of black and white recordings or improving or modifying the coloring of recordings. Indeed, any artifacts or unwanted features of images or videos recorded with older or non-optimal equipment may be reduced. Modifications may also include, for instance, super resolution, artistic or other visual effects and deepfakes.

In an exemplary implementation, the architecture of a neural network may be based on an U-shaped machine learning structure. An example of such structure is U-Net. U-Net is a convolutional neural network (CNN) that was originally developed for biomedical image segmentation, but has also been used in other related technical fields, e.g. super-resolution. In the following, the term U-net is employed in a broader manner, referring to a general U-shaped neural network structure.

An example of a small U-shaped network (U-Net) is shown in FIG. 1. FIG. 2 shows an example with more processing stages. The U-Net shows a contracting path 299 and an expansive path 298, which gives it the u-shaped architecture. The contracting path is a convolutional network that comprises repeated stages of convolutions, each followed by downsampling of the image, e.g. the rectified linear unit (ReLU) activation function and a max pooling operation. During the contraction, the spatial information is reduced while feature information is increased. The expansive pathway combines the feature and spatial information through a sequence of up-convolutions and concatenations with high-resolution features from the contracting path. In other words, the exemplary U-net in FIG. 2 includes a plurality of processing stages with downsampling and (at least one) convolution and a plurality of stages with upsampling and convolution. The downsampling modules reduce resolution of the image on their input. Thus, at each stage of the contracting path, the resolution of the image gets smaller. At each stage, the convolution module thus analyses image features which are of importance for a particular resolution, from finer to coarser. The convolution refers to feature analysis which employs a predefined mask (pattern) to each sample of the image on the input of the convolution mode. Mathematically, the convolution is calculated for each sample of the image as a sum of sample-wise products of the predefined mask and the image at the position of said sample. It is noted that the convolution as exemplified here is only an advantageous option. In general, the present disclosure is not limited to such convolution. As mentioned above, in general, any kind of filtering including any kinds of feature extraction mechanisms may be applied. The feature analysis may include, for instance, gradient or edge detection, or other features.

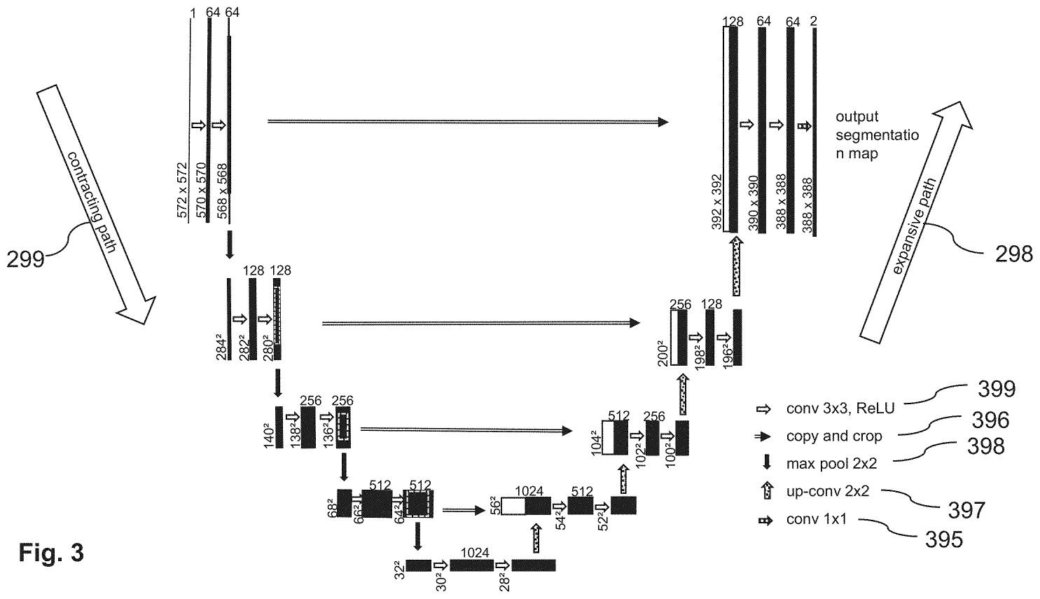

FIG. 3 shows a more detailed example of a U-net like structure corresponding to the one used in https://lmb.informatik.uni-freiburg.de/people/ronneber/u-net. The contracting path in the U-Net shown in FIG. 3 follows the architecture of a convolutional network. Elements of this exemplary U-Net may also be employed in the embodiments of the present application. It shows repeated application (to an image tile) of two 3×3 convolutions (here unpadded convolutions), each followed by a rectified linear unit (ReLU) 399 and a 2×2 max pooling operation 398 with stride 2 for downsampling. Each box in FIG. 3 corresponds to a multi-channel feature map. In particular, an input image tile with a size of 572×572 samples is processed. After a first convolution as well as after the second convolution, 64 feature channels are generated. The difference between the size of the input image and the sizes of the feature channels (570×570 and 568×568) are caused by the fact that the convolution is not padded and thus, for the samples at the image boundary, the convolution cannot be properly calculated. At each downsampling step the number of feature channels is doubled (see the following stages with 128, 256, 512, and finally 1024 feature channels).

Every step in the expansive path includes an upsampling of the feature map followed by a 2×2 convolution (up-convolution) 397 that halves the number of feature channels, a concatenation with the correspondingly cropped feature map from the contracting path, and two 3×3 convolutions, each followed by a ReLU. The cropping 396 is done due to the loss of border pixels in every convolution, mentioned above. At the final layer a 1×1 convolution 395 is used to map each 64-component feature vector to the desired number of classes. In total, this exemplary network has 23 convolutional layers. To allow a seamless tiling of the output segmentation map, the input tile size may be selected such that all 2×2 max-pooling operations are applied to a layer with an even x- and y-size.

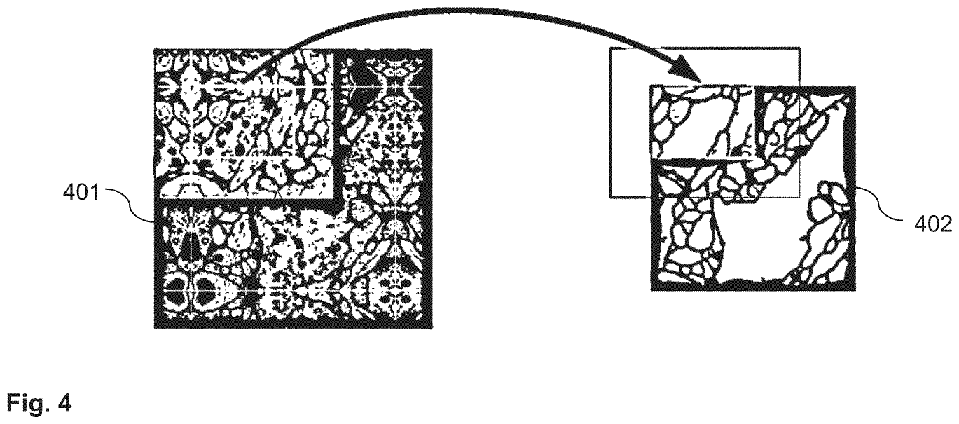

U-Net is a convolutional neural network (CNN) that was originally developed for biomedical image segmentation. In segmentation, the network input is an image and the network output is a segmentation mask, which assigns each pixel to a certain class label. An example of such an input and output is shown in FIG. 4 from https://lmbinformatik.uni-freiburg.de/people/ronneber/u-net. The input is an Electron microscope picture 401 of neuronal structures which is segmented using a U-Net to generate a segmentation mask 402 To employ the U-Net for image filtering such as post-processing and in-loop filtering, where both network input and network output are images, conventional U-Nets with the structure as described above may be unsuitable.

The network structure mentioned above, may be employed by the methods and apparatuses of the present disclosure with some modifications, which will be described in more detail later on. As usual with neural networks, there are two modes in which the neural network works: learning and operation. Learning may generally be a supervised or an unsupervised learning. During a supervised learning, the network is presented with a training data set including pairs of input image (e.g. distorted image) and a desired output image (e.g. enhanced image). For the purpose of image modification, the supervised learning may be employed. It is noted that the present disclosure is not limited to the cases in which both learning and operation modes are supported. In general, a network does not have to undergo the learning process. For example, the weights may be obtained from another source and the network may be directly configured with the proper weights. In other words, once one neutral network is properly trained, the weights may be stored for later use and/or provided to configure other network(s).

The desired image may be an original image, for instance, an undisturbed image. The input image may be a disturbed version of the original image. For instance, the undisturbed image may be an uncompressed or losslessly compressed image. The disturbed image may be based on the undisturbed image after being compressed and subsequently decompressed. For instance, in compression an decompressing, BPG or HEVC may be used both during training and testing. The CNN may then learn a filter to reduce the compression artifacts and to enhance the image.

In this example, during learning, the parameters of the network are adapted to make the enhanced image resemble the uncompressed image more than the decompressed image. This can be done with the help of a loss function between the original, uncompressed image and the enhanced image.

However, the input image may also be an undisturbed image and the original image a manually or otherwise modified image. In such a configuration, the neural network may modify images such that they resemble the modification that was applied to a training set of images in more images that are similar to the undisturbed images of the training set in some way.

Correspondingly, when the correction image is combined with the input image, the resulting image may resemble the original image better than the input image. For instance combining the correction image with the input image may correspond to adding the pixel values of both images, i.e. pixel-wise addition. However, this is just an example, and further ways to combine the correction image with the input image may be used as described later. It is noted that in the present disclosure, the terms “pixel” and “sample” are employed interchangeably.

According to some embodiments, the processing does not output directly the enhanced/modified image. Rather, it outputs a correction image. In an example, the correction image may be a difference image. For instance the correction image may correspond to the difference between the input image and an original image (may be also referred to in general as desired image or target image).

According to an embodiment, the correction image and the input image have the same size, meaning the same horizontal and vertical dimensions and the same resolution, and the correction image is the difference image and the combining is performed by addition of the difference image to the input image.

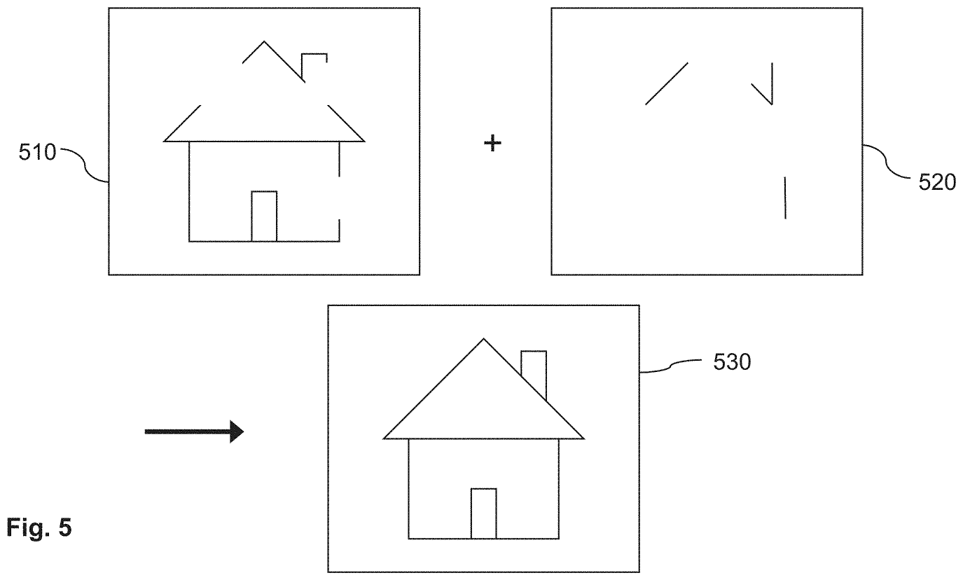

A schematical example for a combination of the difference image with the input image is shown in FIG. 5. In this example, 510 is the input image. The neural net creates the correction image 520. Adding the input image and the correction image can result in an enhanced version 530 of the input image. Advantages may include that the neural net only needs to create a difference image and not the complete modified image. For instance in a case that the present method is used to improve frames of a video, the difference image may usually be less complex than the final modified image. This may mean that the correction image comprises less degrees of freedom (information) than the enhanced image. Consequently, the neural net may operate more efficiently.

However, combining the correction image with the input image may also correspond to other operations such as, for instance, averaging, filtering the input image using the correction image or replacing pixels of the input image using pixels from the correction image. In a configuration where pixels are replaced, the combination may for instance choose which pixels to be replaced based on a threshold. Those pixels of the correction image that are represented by a value above a threshold may be chosen to replace the corresponding pixels in the input image. Furthermore, combining may, for instance, be based on weighted or local combination of the two images. Moreover, the combining of the input image with the correcting image may include—alternatively or in addition—non-linear operations such as clipping, multiplying, or the like.

In this example, the correction image and the input image have the same dimension in x and y direction. However, in some embodiments the correction image may have different dimensions. For instance the correction image may provide one or more local patches to be combined with the input image. Furthermore, the correction image may differ from the input image in having a different resolution. For instance, the correction image may have a higher resolution than the input image. In such a configuration, the correction image could, for instance, be used to sharpen features of the input image and/or to increase the resolution of images or videos.

FIG. 2 shows an example for a neural net applied in the present embodiment. The exemplary network shown in FIG. 2 shows of a contracting path and an expansive path, which gives it the u-shaped architecture. Furthermore, the network combines the correction image resulting from the contracting and the expansive path with a unmodified copy of the input image. During the contraction, the spatial information is reduced while feature information is increased. The expansive pathway combines the feature and spatial information through a sequence of up-convolutions and concatenations with high-resolution features from the contracting path. The contracting path in this example is a convolutional network that includes repeated application of convolutions, each followed by a rectified linear unit (ReLU) activation function and a max pooling operation to downsample the image as described above. However, different downsampling operations and activation functions may be used as described later in various embodiments of the present invention.

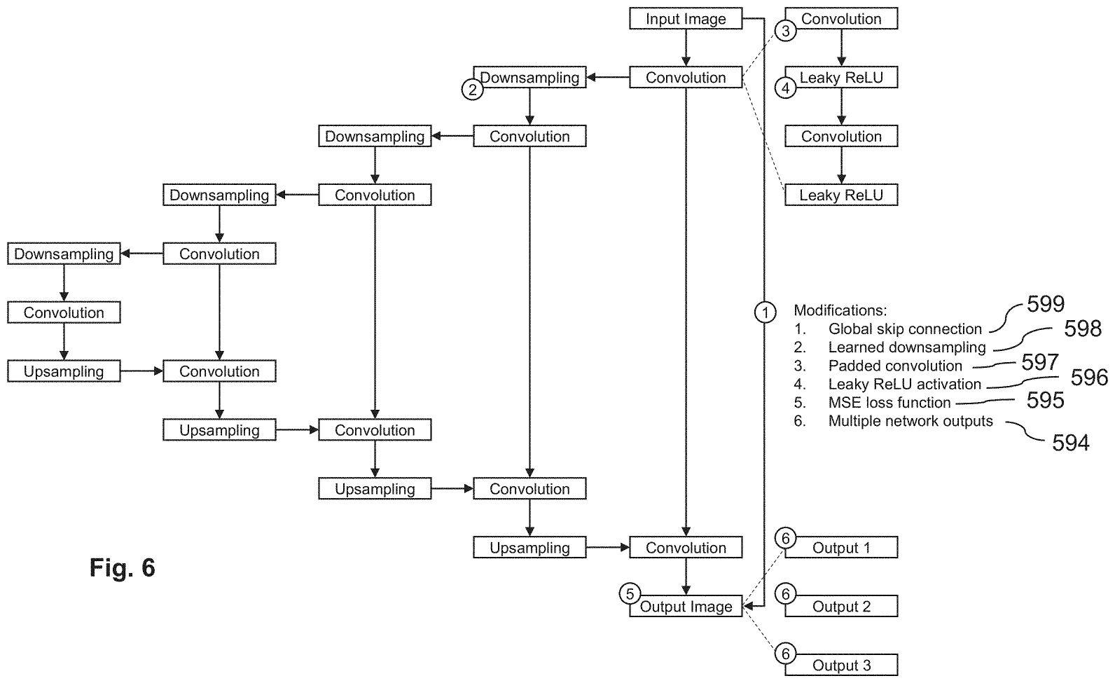

FIG. 6 shows an overview over techniques that may be used in different exemplary embodiments that will be described in more detail below. In particular, FIG. 6 shows an U-shaped neural network structure which is somewhat similar to the U-net of FIG. 2. However, there are techniques applied to the U-net in order to improve its performance. These techniques may be applied alternatively or in combination. The combination may be any combination of two or more of the techniques or of all of them. The circled single digit numbers in FIG. 6 show where the techniques are applied within the network. As noted above, for instance, learned downsampling 598 may be used in the downsampling stages. Each technique corresponding to one of the circled single-digit numbers will be explained in more detail below.

As described above, the contracting and expansive paths of a network according to the present application can also be found in U-Nets. Accordingly, a method according to the present application may be considered as based on a modified U-Net.

In particular, in an exemplary implementation, the neural network is based on a U-net, and for establishing the neural network, the U-net is modified by introducing a skip connection 599 to such U-net, the skip connection 599 is adapted to connect the input image with the output image. The skip connection 599 may be implemented by storing a copy of the input image in a storage that is not affected by the neural net. When the neural net created the correction image, the copy of the input image may be retrieved and combined with the correction image created by the neural net.

The image modification as described above may be readily applied to the existing or future video codecs (encoders and/or decoders). In particular, the image modification may be employed for the purpose of in-loop filtering at the encoder and the decoder. Alternatively, or in addition, the image modification may be employed in a post-filter at a decoder. An in-loop filter is a filer which is used in the encoder and in the decoder after reconstructing the quantized image for the purpose of storing the reconstructed image in a buffer/memory in order to use it for prediction (temporal or spatial). The image modification can be used here to enhance the image and to reduce the compression artifacts. A post filter is a filter applied to the decoded image at the decoder before rendering the image. The post-filter may also be used to reduce the compression artifacts and/or to make the image visually pleasing or to provide the image with some special effects, color corrections, or the like.

In image/video post-processing and in-loop filtering both, network input signal and neural network output signal are images. It is noted that the image modification may be employed for encoding and/or decoding of still images and/or video frames. However, encoding and decoding are not the only applications for the invention. Rather, a stand-alone image modification deployment is possible, such as an application for enhancing images or videos by adding some effects, as already mentioned above.

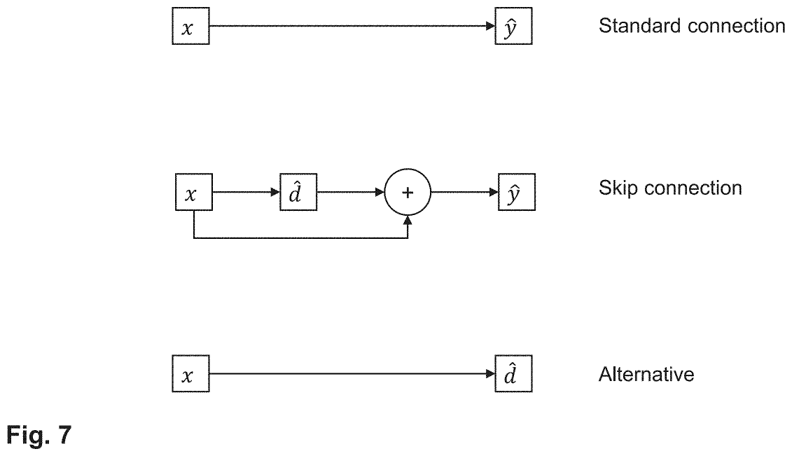

In case of the usage for encoding/decoding, the input and output images are mainly similar, since the CNN only tries to reverse the compression artifacts. Therefore, it is particularly advantageous to introduce a global skip connection 599 from the input image to the output image of the network. An example for this is shown in FIG. 7. Thus, the CNN only has to learn the difference between input image (decompressed image) and original image (uncompressed image), instead of transforming the input image into the original image. This simplifies the training of the network. In the example shown in FIG. 7, is the decompressed input image, y the original uncompressed image, and the filtered output image. In the normal case with a standard connection, the CNN transforms image x into image by applying a learned filter.

Since image x and y are very similar, however, the learning is simplified by forwarding x with a global skip connection 599. The network now only learns the difference d between x and y

d=y−x.

Alternatively, one could rewrite the output of the network from

f(x)=ŷ

to

f(x)=\hat{d}

and adapt the loss function accordingly. Here, \hat{d} represents estimation of the correction image obtained by function f, which is the function describing the processing by the neural network.

According to another embodiment, the neural network is parametrized according to a value of a parameter indicative of an amount or type of distortion of the input image.

Compressing images is always a tradeoff between compression rate and image quality. In general, the less an image is compressed, the better the image quality of the compressed image. Since different compression levels introduce different compression artifacts, instead of training a single CNN to deal with all different compression levels, a specific CNN may be trained for each compression level. This may further improve the visual quality of the filtered image, since the specific network can better adapt to the specific compression level.

In some implementations, one or more parameters may indicate which compression level and/or which compression technique (codec) is used to compress the image or video. These parameters may indicate which CNN structure should be used to enhance the decompressed image or video. The parameters may be used to determine the structure of the neural net in the learning as well as in applying the neural net to decompressed images. In some implementations, the parameters may be transmitted or stored together with the image data. However, in some implementations, the corresponding parameters may be determined from the decompressed images. In other words, properties of the decompressed images may be used to determine the structure of the neural net that is then used to improve the decompressed images. For example, such parameter may be quantization step or another quantization parameter reflecting quantization step. In addition or alternatively, further encoder parameters such as prediction settings may be used. For instance, intra and inter prediction may result in different artifacts. The present disclosure is not limited to any particular parameters. bit depth and application of a particular transformation or filtering approached during encoding and decoding are further examples of parameters which may be used to parametrize or train the neural network.

Furthermore, in some implementations, a set of parameters describing the neural net entirely may be transmitted or stored with images or videos or sets of images or videos. The set of parameters may include all parameters including weights that were learned using the corresponding set of images.

In other implementations, the weights of the neural net may be learned with a set of training data. The training data can be any set of images or videos. The same weights may then be used to improve any input data. Specifically, all videos or images that are compressed with the same compression technique and the same compression rate may be improved using the same neural net and no individual weights have to be transmitted or stored together with each video or image. Advantages may be that a larger set of training data can be used to train the neural net and that less data overhead is necessary in the transmitting or storing of compressed images or videos.

According to an advantageous embodiment, the image down-sampling is performed by applying a strided convolution and/or by applying a padded convolution 597.

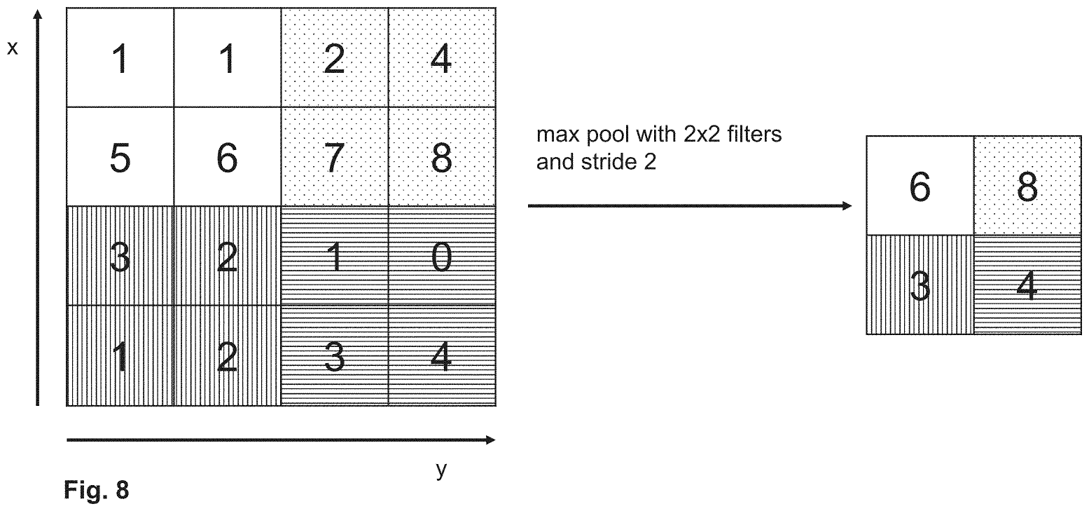

The original U-Net uses max pooling to downsample the input image on the contracting path. Max-pooling is a form of non-linear downsampling. It partitions the input image into a set of non-overlapping rectangles and, for each such sub-region, outputs the maximum. FIG. 8 shows an example of max pooling. Given an image x, the size of the pooling mask s as well as row index r, and column index c, which identify the pixel of x, the max-pooling operation is defined as follows:

$${\tilde{x}}_{r , c} = \text{?} {x}_{2 r + i , 2 c + j} . \\ \text{?} \text{indicates text missing or illegible when filed}$$

In the example shown in FIG. 8 an exemplary max pooling operation with 2×2 filters is shown. In this example, 4×4 pixels are pooled to 2×2 pixels. The same method can also be applied to arrays with dimensions other than 4×4. First, the 4×4 input is separated in 2×2 arrays in this example. From each 2×2 array, the maximum value is determined. The value of each maximum is then used to fill the corresponding field in the new 2×2 pixel array.

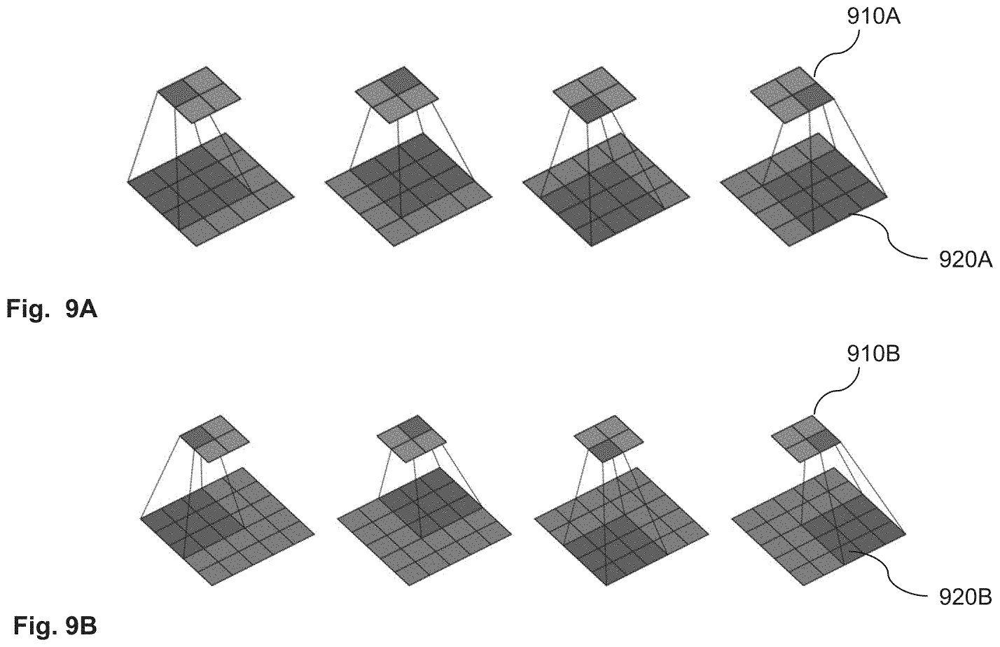

Max pooling with pooling size s=2 therefore quarters the resolution of x, i.e. x is halved in width and halved in height. This naturally introduces an information loss. To limit this loss, instead of using max pooling, the method according to the present embodiment uses strided convolutions for downsampling the image. The stride defines the step size of the kernel when traversing the image. While its default is usually one, a stride of two can be used for downsampling an image similar to max pooling. However, other strides may be used as well. While in standard (non-strided) convolution the stride of the convolution is one, in strided convolution, the stride of the convolution is larger than one. This results in a learned downsampling 598 of the input image. The difference between standard (non-strided) convolution and strided convolution is shown in FIG. 9A and FIG. 9B.

In particular, FIG. 9A shows a convolution with stride equal to 1 (non-strided). Portion of image 920A with the size 4×4 samples is downsampled to image 910A of the size 2×2 samples. Each sample of the downsampled image 910A is obtained on the basis of nine samples of a 3×3 a sub-region of the image 920A. The sub-regions contributing to the samples of the downsampled image 910A are overlapping, and their centers are in the neighboring samples, i.e. in a distance of one from each other, corresponding to the stride equal to 1.

FIG. 9B shows a convolution with stride 2. Similarly as in FIG. 9A, portion of image 920B with the size 5×5 samples is downsampled to image 910B of the size 2×2 samples. Each sample of the downsampled image 910B is obtained on the basis of nine samples of a 3×3 sub-region of the image 920A. The sub-regions contributing to the samples of the downsampled image 910A are overlapping, and their centers are in a distance of two samples from each other, corresponding to stride equal to 2.

Let again x be the input image with a depth of kᵢₙ, w the weights of the network and kₒᵤₜ the depth after downsampling, which is usually doubled, i.e. kₒᵤₜ=2·kᵢₙ. The convolved and downsampled image \tilde{x} is then defined as:

$${\tilde{x}}_{i , j , {k}_{out}} = {\sum }_{m = - 1}^{1} {\sum }_{n = - 1}^{1} {\sum }_{{k}_{i n} = 1}^{{k}_{out}} {w}_{m , n , {k}_{i n} , {k}_{out}} \cdot {x}_{2 i + m , 2 j + n , {k}_{i n}} ,$$

In other words, the weights w determine the contribution of the respective samples from the image 920A,920B to the donwsampled image 910A, 910B. Thus, the weights filter the input image at the same time as they perform the downsampling. These weights may be fixed in some implementations. However, they may also be trained.

The strided convolution is applied herein as downsampling. Still, a filtering is performed after the downsampling, as shown in FIG. 6. However, it is noted that in some implementation, at least a part of the filtering may be already performed by the convolution with the appropriately set weights (to perform the desired feature extraction/filtering). In such implementation, computational power may be saved by such joint downsampling and filtering.

Furthermore, in addition or alternatively to the strided convolution, padded convolution 597 may be used. Due to unpadded convolutions in the original U-Net, the resolution of the network output is smaller than the resolution of the network input by a constant border width, as was discussed above with reference to FIG. 2. For post-processing and in-loop filtering this behavior may be disadvantageous, since input image and output image should have the same resolution.

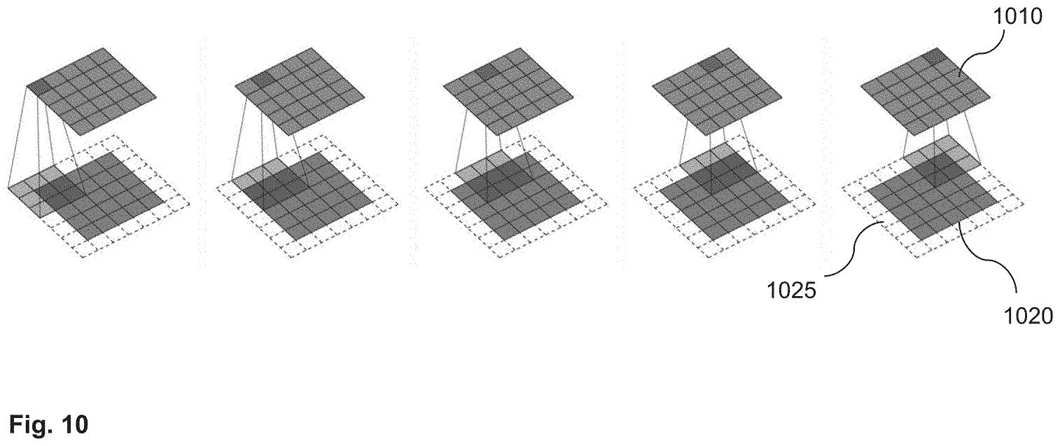

For this reason, padded convolutions may be employed instead of unpadded convolutions. In padded convolution 597 extra pixels of a predefined value are padded around the border of the input image, thus increasing the resolution of the image, which is then decreased to the original resolution after the convolution for other purposes. Typically, the values of the extra pixels may all be set to 0. However, different strategies can be chosen to fill the extra pixels. Some of these strategies may include filling the corresponding pixels with an average of nearby pixels or, for instance, with the minimum value of the nearby pixels. Nearby pixels may be adjacent pixels or pixels within a predetermined radius. FIG. 10 illustrates the concept of the padded convolution. The dashed boxes 1025 are the additional pixels padded around the original image 1020 to maintain the resolution after convolution leading to a convolved image 1010. In particular, as can be seen in the first of the series of images in FIG. 10, when performing convolution on the position of a corner sample, there are no further samples surrounding the corner sample on two sides (top and left in the first image and top right in the last image of FIG. 10). In order to still enable computation of the convolution, additional samples 1025 are added to the location immediately neighboring the image 1020. This addition may be extrapolation of the pixels of the image 1020, or fixed and predefined values, or the like. It is noted that in this simple example, due to the convolutional mask size of 3×3, only a single additional sample is necessary on the image 1020 boundary. However, for larger mask dimensions, more than one additional samples would be necessary around the image 1020. The padded convolution and the strided convolution may be applied in combination.

However, it is noted that the present invention is not limited to using padded convolution 597. Rather, unpadded convolution or other techniques to handle the borders may be applied.

In an embodiment, the activation function of the neural network is a leaky rectified linear unit activation function 596.

The original U-Net uses rectified linear units (ReLUs) as non-linear activation functions, which are defined as follows:

f(x)=max(0,x).

In other words, this means that negative values are cut to zero. Consequently there is no more gradient in values that have previously been negative.

Using such standard ReLUs might be problematic during training due to zero gradient information. Having values of always below 0 results in no learning of the network.

Using leaky ReLUs, as an activation function, however, may result in faster learning and better convergence due to more gradient information. The leaky ReLU is defined as follows:

$$f ( x ) = \{ \begin{matrix}x if x \geq 0 \\ α \cdot x otherwise .\end{matrix}$$

In other words, values larger than zero are unaffected and negative values are scaled. The scaling factor may be a number smaller than 1 in order to reduce the absolute magnitude of the negative values. Alternatively, any other activation function like, for instance, a softplus activation function may be used.

To improve the visual quality of video frames, the present disclosure provides methods and apparatuses which can be employed as a post-processing filter or as an in-loop filter.

As already mentioned above, image filtering can be used in video processing in different ways. A coder and a decoder both try to reconstruct images that are as close to the original image as possible. In doing so, it can be advantageous to filter every frame of the video when it is reconstructed. The filtered image can then be used to enable a better prediction of the next frame (loop filtering).

In some embodiments, post-processing of the images may be advantageous. In such a case, the filter may be applied to each frame after it is decoded before the frame or image is displayed or saved or buffered. Prediction of the next frame, may still be based on the decoded, but unfiltered last frame. According to an embodiment, a method for reconstructing an encoded image from a bitstream is provided, wherein the method includes decoding the encoded image from the bitstream, and applying the method for modifying an input image according to any of the embodiments described above with the input image being the decoded image.

In such a method, any video encoding/decoding technique can be used. The frames are filtered afterwards. In other words, the filtering can be applied independent from the coding/decoding. This may be helpful to improve the visual quality of any compressed video without changing the encoding/decoding method. As described above, the filter may be adapted to the coding method and/or to the compression rate.

Alternatively, in video coding, the frames may be filtered in-loop (loop filter). This may mean that frames are filtered before they are used in the prediction of further frames. Correspondingly, according to an embodiment, a method for reconstructing a compressed image of a video is provided, comprising reconstructing an image using an image prediction based on a reference image stored in a memory, applying the method for modifying enhancing an input image as described above, with the input image being the reconstructed image, and storing the modified image into the memory as a reference image.

Using filtered images in the prediction of consecutive frames, regions of frames or blocks may facilitate and/or improve the accuracy of the prediction. This may reduce the amount of data required to store or transmit a video without reducing the accuracy of the prediction of consecutive blocks or frames.

The same loop filter that is used in the decoding of a video may also be used in the encoding.

For neural nets according to embodiments of the present application to modify images and videos such that the modified images resemble the target image, an efficient training of the networks parameters (i.e. the weights of the neural net) is desired. Accordingly, a method for training a neural network for modifying a distorted image is provided, comprising inputting to the neural network pairs of a distorted image as a target input and a correction image as a target output, the correction image being obtained based on an original image, wherein processing with the neural network includes at least one stage including an image down-sampling and a filtering of the down-sampled image; and at least one stage of an image up-sampling, adapting at least one parameter of the filtering based on the inputted pairs.

According to this embodiment supervised learning techniques may be used to optimize the network parameters. The aim of the learning may be for the network to create, from the target input, a correction image as a target output. To achieve this, after applying the neural net to the target input, the generated output (the correction image) is added to a copy of the target output. This may be achieved with a skip connection 599. Subsequently, a loss function may be calculated.

According to an embodiment, the adapting of the at least one parameter of the filtering is based on a loss function 595 corresponding to Mean Squared Error (MSE).

The original U-Net was developed for biomedical image segmentation. In segmentation the input to the network is an image and the output of the network is a segmentation mask. A segmentation mask assigns each image pixel to a certain class label. As a loss function the cross-entropy was used, which measures the distance between two probability distributions.

For in-loop filtering, the cross-entropy loss function may be not optimal. To measure the quality of reconstruction of lossy image compression, the peak signal-to-noise ratio (PSNR) may be a better metric, which can be defined via the mean squared error (MSE). Given the original uncompressed image y with width w and height h, and the corresponding filtered output image ŷ, the MSE loss function 595 is defined as:

$$l ( y , \hat{y} ) = \frac{1}{w \cdot h} {\sum }_{i = 1}^{w} {\sum }_{j = 1}^{h} {( {y}_{i , j} - {\hat{y}}_{i , j} )}^{2}$$

However, the present invention is not limited to using the MSE as the loss function 595. Other loss functions, some of which might be similar to the MSE loss function 595 may be used. In general, alternative other functions known from image quality assessment may be used. In some embodiments, loss functions may be used that are optimized for measuring the perceived visual quality of the images or video frames. For instance, weighted loss functions may be used which may lay weight on, for instance, reducing certain types of defects or residuals. In other embodiments, the loss function may lay weight on certain areas of the image. In general, it may be advantageous to adapt the loss function to the kind of image modification the neural net should be used for.

Furthermore it may be advantageous to use several output channels (color channels) in the loss function. According to an embodiment, the adapting of the at least one parameter of the filtering is based on a loss function including a weighted average of squared errors for more than one color channels 594.

Instead of computing the loss function with a single network output, the network according to the present embodiment has multiple output channels 594. For example, in FIG. 6, there are three outputs 1, 2, and 3. This allows to individually weight the importance of different parts inside the loss function during network training. Let x be the decompressed input image, y be the original uncompressed image, ŷ be the filtered enhanced image and α, β, and γ be scalar weighting constants. Furthermore, let the images be in the RGB color space, with red R, green G, and blue B. The mean squared error loss function for multiple outputs may then be calculated as follows:

l(y,ŷ)=α(y_{R}−ŷ_{R})²+β(y_{G}−ŷ_{G})²+γ(y_{B}−ŷ_{B})²

In the YUV color space with luminance Y, and chrominance U and V, the loss function is calculated as follows:

l(y,ŷ)=α(y_{Y}−ŷ_{Y})²+β(y_{U}−ŷ_{U})²+γ(y_{V}−ŷ_{V})²

It is noted that the present disclosure is not limited to these examples. In general, it is not necessary to weight all color channels. For example, the weighting may be performed only for two of three channels, or the like.

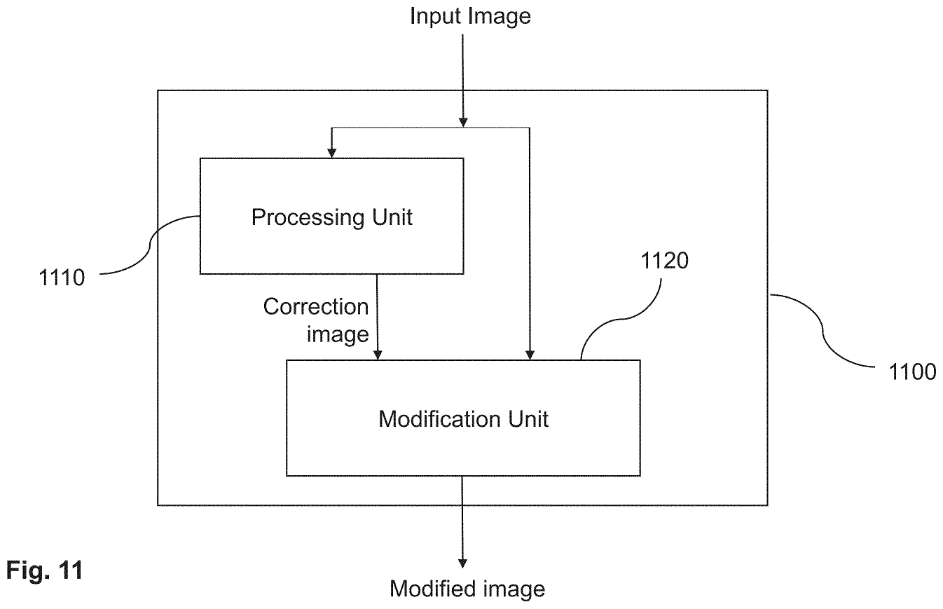

FIG. 11 shows an example for a device 1100 for modifying an input image according to any of the above described methods. The processing unit 1110 is configured to generate a correction image by processing the input image with a neural network. The processing with the neural network comprises at least one stage including image down-sampling and filtering of the down-sampled image; and at least one stage of image up-sampling, and the modification unit 1120 is configured to modify the input image by combining the input image with the correction image.

Here, filtering parameters (weights) may be machine-learned (trained). However, as mentioned above, further parameters may be learned, such as convolution weights of the convolution used for downsampling.

According to an aspect, a method is provided for modifying an input image, the method comprising: generating a correction image by processing the input image with a neural network, wherein the processing with the neural network includes at least one stage including image down-sampling and filtering of the down-sampled image; and at least one stage of image up-sampling; and modifying the input image by combining the input image with the correction image.

This approach provides an efficient processing in which only the correction image instead of the entire image is learned and produced in order to modify an input image.

In an exemplary implementation, the correction image and the input image have the same vertical and horizontal dimensions. The correction image is a difference image and the combining is performed by addition of the difference image to the input image.

Provision of the difference image with the same size as the input image enables a low-complexity combining and processing.

For instance, the neural network is based on a U-net. For establishing the neural network, the U-net is modified by introducing a skip connection to such U-net, the skip connection is adapted to connect the input image with the output image.

U-net has a structure advantageous for image processing. Employment of the U-net also enables to make at least partially use of some available implementations of some processing stages or further modifications thereof, possibly leading to a more easy implementation.

In an embodiment, the neural network is parametrized according to a value of a parameter indicative of an amount or type of distortion of the input image.

Parametrizing the neural network with a type of distortion or an amount of distortion may help to train the network specifically for different kinds and amounts of distortion and thus, to provide more accurate results.

According to an embodiment, the image down-sampling is performed by applying a strided convolution and/or by applying a padded convolution.

Applying the strided convolution may provide for complexity reduction, while the employment of a padded convolution may be beneficial for maintaining the image size throughout the processing.

In an exemplary implementation, the activation function of the neural network is a leaky rectified linear unit (ReLU) activation function. A leaky ReLU comes close to the sigmoid function and enables for an improved learning.

According to an aspect, a method is provided for reconstructing an encoded image from a bitstream. The method includes decoding the encoded image from the bitstream, and applying the method for modifying an input image as described above with the input image being the decoded image. This corresponds to an application of the processing as a post-filter, e.g. to reduce compression artifacts, or to address particular perceptual preferences of the viewers.

According to an aspect, a method for reconstructing a compressed image of a video, comprising: reconstructing an image using an image prediction based on a reference image stored in a memory; applying the method for modifying an input image as mentioned above with the input image being the reconstructed image; and storing the modified image into the memory as a reference image. This corresponds to an application of the processing as an in-loop filter, e.g. to reduce compression artifacts during the encoding and/or decoding process. The improvement is not only on the level of the decoded image, but due to the in-loop application, the prediction may also be improved.

According to an aspect, a method is provided for training a neural network for modifying a distorted image, the method comprising: inputting to the neural network pairs of a distorted image as a target input and a correction image as a target output, the correction image being obtained based on an original image; wherein processing with the neural network includes at least one stage including an image down-sampling and a filtering of the down-sampled image; and at least one stage of an image up-sampling; and adapting at least one parameter of the filtering based on the inputted pairs.

For example, the adapting of the at least one parameter of the filtering is based on a loss function corresponding to Mean Squared Error (MSE).

Alternatively, or in addition, the adapting of the at least one parameter of the filtering is based on a loss function including a weighted average of squared errors for more than one color channels.

According to an aspect, a computer program is provided, which when executed on one or more processors causes the one or more processor to perform the steps of the method as described above.

According to an aspect, a device for modifying an input image is provided. The device comprises: a processing unit configured to generate a correction image by processing the input image with a neural network, wherein the processing with the neural network includes at least one stage including image down-sampling and filtering of the down-sampled image; and at least one stage of image up-sampling, and a modification unit configured to modify the input image by combining the input image with the correction image.

According to an aspect, a device is provided for reconstructing an encoded image from a bitstream, the device comprising: a decoder unit configured to decode the encoded image from the bitstream, and the device configured to modify the decoded image as described above.

According to an aspect, a device for reconstructing a compressed image of a video, the device (apparatus) comprising: a reconstruction unit configured to reconstruct an image using an image prediction based on a reference image stored in a memory; the device configured to modify the decoded image as describe above; and memory unit for storing the modified image as a reference image.

According to an aspect, a device is provided for training a neural network for modifying a distorted image, the device comprising: a training input unit configured to input to the neural network pairs of a distorted image as a target input and a correction image as a target output, the correction image being obtained based on an original image; a processing unit configured to process with the neural network, wherein processing with the neural network includes at least one stage including an image down-sampling and a filtering of the down-sampled image; and at least one stage of an image up-sampling; and an adaption unit configured to adapt at least one parameter of the filtering based on the inputted pairs.

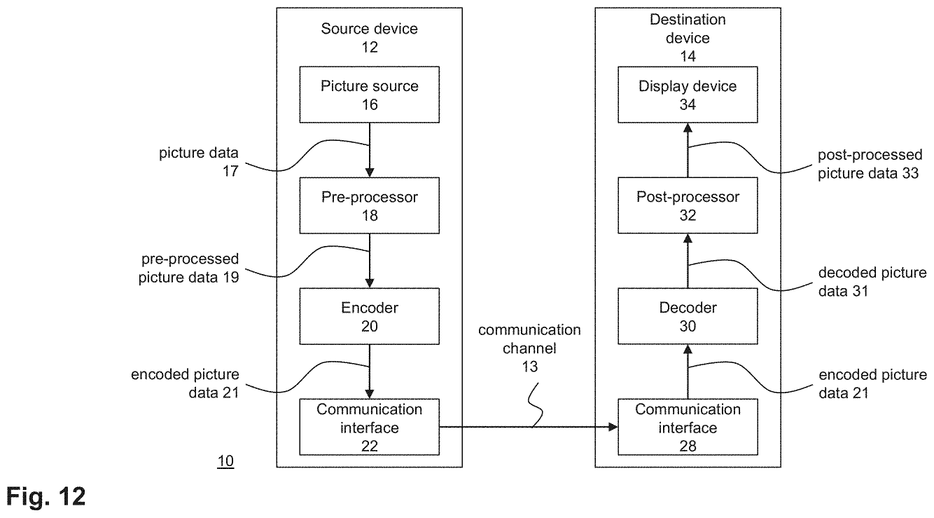

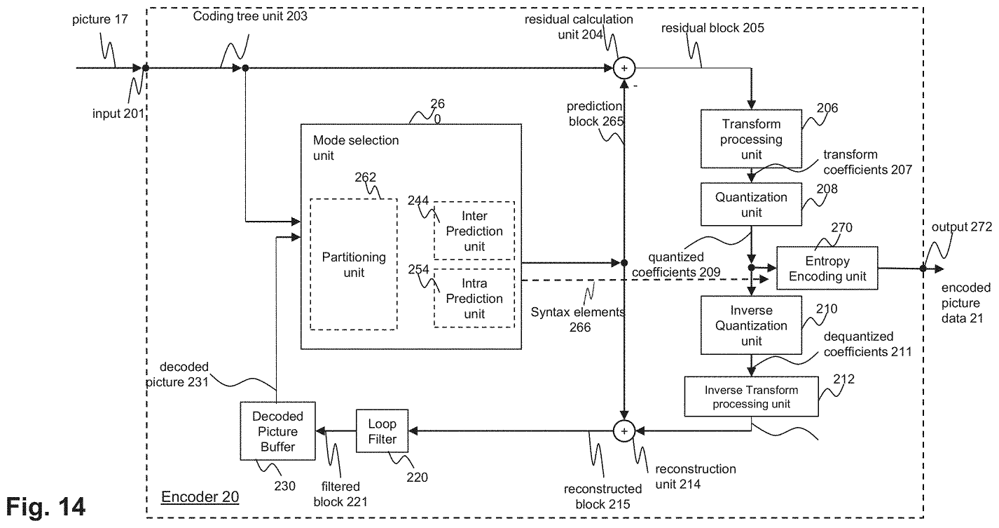

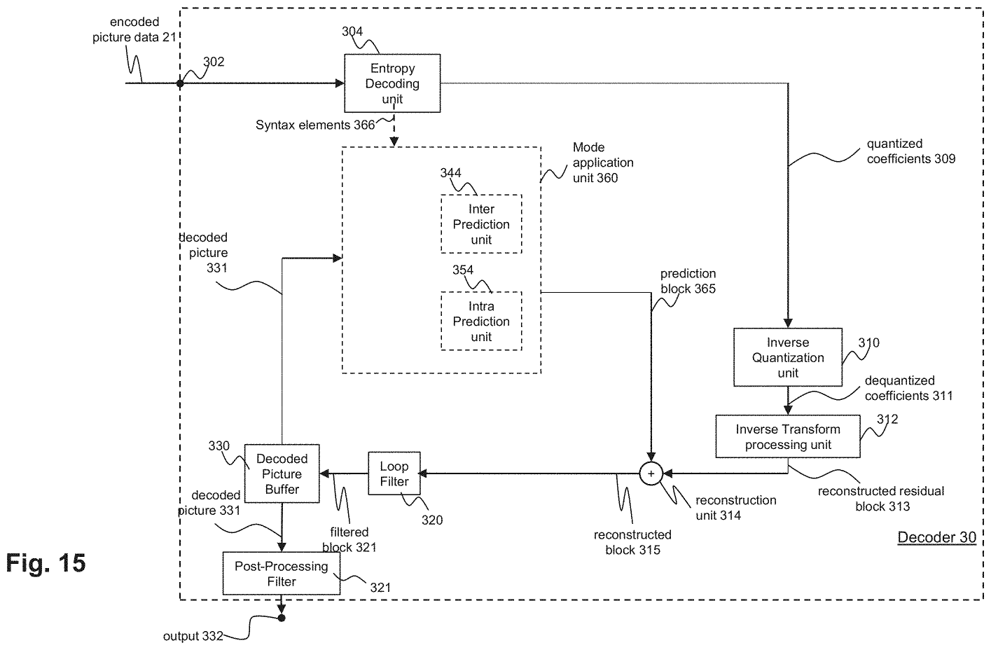

An exemplary system which may deploy the above-mentioned processing is an encoder-decoder processing chain (coding system 10) illustrated in FIG. 12. The coding system 10 includes a video encoder 20 and a video decoder 30 which are described in more details based on FIGS. 14 and 15, and which may implement the above-mentioned image modification on the position of an in-loop filter or post filter.

FIG. 12 is a schematic block diagram illustrating an example coding system 10, e.g. a video coding system 10 (or short coding system 10) that may utilize techniques of this present application. Video encoder 20 (or short encoder 20) and video decoder 30 (or short decoder 30) of video coding system 10 represent examples of devices that may be configured to perform techniques in accordance with various examples described in the present application.

As shown in FIG. 12, the coding system 10 comprises a source device 12 configured to provide encoded picture data 21 e.g. to a destination device 14 for decoding the encoded picture data 13. The source device 12 comprises an encoder 20, and may additionally, i.e. optionally, comprise a picture source 16, a pre-processor (or pre-processing unit) 18, e.g. a picture pre-processor 18, and a communication interface or communication unit 22.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17. Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from RGB to YCbCr), color correction, or de-noising. It can be understood that the pre-processing unit 18 may be optional component. It is noted that embodiments of the present invention relating to the modification of an image may also be employed in pre-processing in order to enhance or denoise the images (video frames).

The video encoder 20 is configured to receive the pre-processed picture data 19 and provide encoded picture data 21 (further details will be described below, e.g., based on FIG. 14).

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 comprises a decoder 30 (e.g. a video decoder 30), and may additionally, i.e. optionally, comprise a communication interface or communication unit 28, a post-processor 32 (or post-processing unit 32) and a display device 34. The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, for instance, configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both, communication interface 22 and communication interface 28 may be configured as unidirectional communication interfaces as indicated by the arrow for the communication channel 13 in FIG. 12 pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission.

The decoder 30 is configured to receive the encoded picture data 21 and provide decoded picture data 31 or a decoded picture 31. As already mentioned above, the decoder may implement the image modification within the in-loop filter and/or within the post-filter.

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YCbCr to RGB), color correction, trimming, or re-sampling, or any other processing, e.g. for preparing the decoded picture data 31 for display, e.g. by display device 34. It is noted that the image modification described in the above embodiments and exemplary implementations may be also employed herein as post-proceeding following the decoder 30.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LCoS), digital light processor (DLP) or any kind of other display.

Although FIG. 12 depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the description, the existence and (exact) split of functionalities of the different units or functionalities within the source device 12 and/or destination device 14 as shown in FIG. 12 may vary depending on the actual device and application.

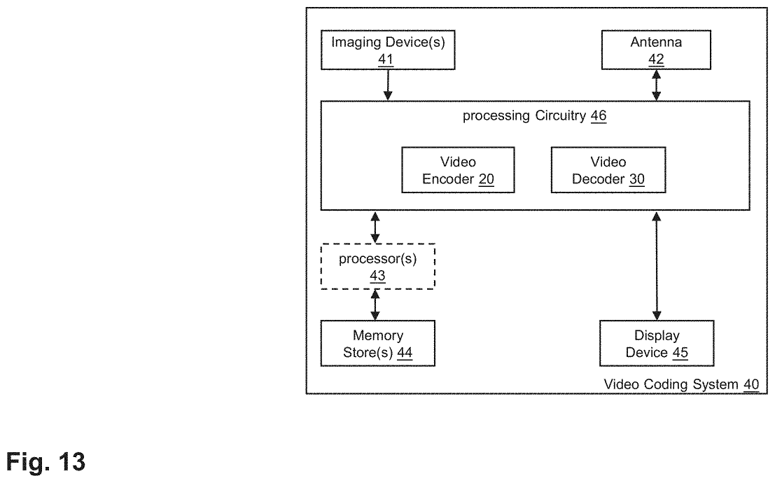

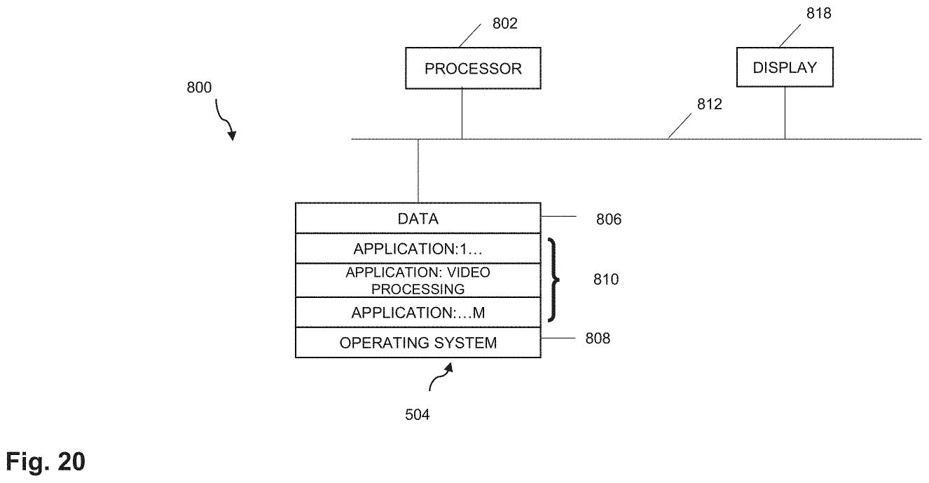

The encoder 20 (e.g. a video encoder 20) or the decoder 30 (e.g. a video decoder 30) or both encoder 20 and decoder 30 may be implemented via processing circuitry 46 as shown in FIG. 13, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody the various modules and/or any other encoder system or subsystem described herein. The decoder 30 may be implemented via processing circuitry 46 to embody the various modules as discussed with respect to decoder 30 of and/or any other decoder system or subsystem described herein. The processing circuitry 46 may be configured to perform the various operations as discussed later. As shown in FIG. 20, if the techniques are implemented partially in software, a device may store instructions for the software in a suitable, non-transitory computer-readable storage medium (memory 44 may be used for that) and may execute the instructions in hardware using one or more processors (within the processing circuitry 46) to perform the techniques of this disclosure. It is possible to provide the system 40 with further processors which may control, e.g. the displaying device 45, the imaging device(s) 41, and the antenna 42 or further devices. Either of video encoder 20 and video decoder 30 may be integrated as part of a combined encoder/decoder (CODEC) in a single device, for example, as shown in FIG. 13.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices (such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 12 is merely an example and the techniques of the present application may apply to video coding settings (e.g., video encoding or video decoding or post-processing) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding and post-processing is performed by devices that do not communicate with one another, but simply encode data to memory and/or retrieve and decode data from memory.

FIG. 14 shows a schematic block diagram of an example video encoder 20 that is configured to implement the techniques of the present application. In the example of FIG. 14, the video encoder 20 comprises an input 201 (or input interface 201), a residual calculation unit 204, a transform processing unit 206, a quantization unit 208, an inverse quantization unit 210, and inverse transform processing unit 212, a reconstruction unit 214, a loop filter unit 220, a decoded picture buffer (DPB) 230, a mode selection unit 260, an entropy encoding unit 270 and an output 272 (or output interface 272). The mode selection unit 260 may include an inter prediction unit 244, an intra prediction unit 254 and a partitioning unit 262. Inter prediction unit 244 may include a motion estimation unit and a motion compensation unit (not shown). A video encoder 20 as shown in FIG. 14 may also be referred to as hybrid video encoder or a video encoder according to a hybrid video codec. It is noted that the present disclosure is not limited to employment within such hybrid encoders. It is nature of the image modification that it can be employed in any kind of encoding or decoding to modify the images, irrespectively of further stages of the video encoding and decoding.

The residual calculation unit 204, the transform processing unit 206, the quantization unit 208, the mode selection unit 260 may be referred to as forming a forward signal path of the encoder 20, whereas the inverse quantization unit 210, the inverse transform processing unit 212, the reconstruction unit 214, the buffer 216, the loop filter 220, the decoded picture buffer (DPB) 230, the inter prediction unit 244 and the intra-prediction unit 254 may be referred to as forming a backward signal path of the video encoder 20, wherein the backward signal path of the video encoder 20 corresponds to the signal path of the decoder (see video decoder 30 in FIG. 3). The inverse quantization unit 210, the inverse transform processing unit 212, the reconstruction unit 214, the loop filter 220, the decoded picture buffer (DPB) 230, the inter prediction unit 244 and the intra-prediction unit 254 are also referred to forming the “built-in decoder” of video encoder 20.

The encoder 20 may be configured to receive, e.g. via input 201, a picture 17 (or picture data 17), e.g. picture of a sequence of pictures forming a video or video sequence. The received picture or picture data may also be a pre-processed picture 19 (or pre-processed picture data 19). For sake of simplicity the following description refers to the picture 17. The picture 17 may also be referred to as current picture or picture to be coded (in particular in video coding to distinguish the current picture from other pictures, e.g. previously encoded and/or decoded pictures of the same video sequence, i.e. the video sequence which also comprises the current picture).

A (digital) picture is or can be regarded as a two-dimensional array or matrix of samples with intensity values. A sample in the array may also be referred to as pixel (short form of picture element) or a pel. The number of samples in horizontal and vertical direction (or axis) of the array or picture define the size and/or resolution of the picture. For representation of color, typically three color components are employed, i.e. the picture may be represented or include three sample arrays. In RBG format or color space a picture comprises a corresponding red, green and blue sample array. However, in video coding each pixel is typically represented in a luminance and chrominance format or color space, e.g. YCbCr, which comprises a luminance component indicated by Y (sometimes also L is used instead) and two chrominance components indicated by Cb and Cr. The luminance (or short luma) component Y represents the brightness or grey level intensity (e.g. like in a grey-scale picture), while the two chrominance (or short chroma) components Cb and Cr represent the chromaticity or color information components. Accordingly, a picture in YCbCr format comprises a luminance sample array of luminance sample values (Y), and two chrominance sample arrays of chrominance values (Cb and Cr). Pictures in RGB format may be converted or transformed into YCbCr format and vice versa, the process is also known as color transformation or conversion. If a picture is monochrome, the picture may comprise only a luminance sample array. Accordingly, a picture may be, for example, an array of luma samples in monochrome format or an array of luma samples and two corresponding arrays of chroma samples in 4:2:0, 4:2:2, and 4:4:4 colour format.

A video encoder 20 may comprise a picture partitioning unit (not depicted in FIG. 14) configured to partition the picture 17 into a plurality of (typically non-overlapping) picture blocks 203. These blocks may also be referred to as root blocks, macro blocks (H.264/AVC) or coding tree blocks (CTB) or coding tree units (CTU) (H.265/HEVC and VVC). The picture partitioning unit may be configured to use the same block size for all pictures of a video sequence and the corresponding grid defining the block size, or to change the block size between pictures or subsets or groups of pictures, and partition each picture into the corresponding blocks.

In further embodiments, the video encoder may be configured to receive directly a block 203 of the picture 17, e.g. one, several or all blocks forming the picture 17. The picture block 203 may also be referred to as current picture block or picture block to be coded.

Like the picture 17, the picture block 203 again is or can be regarded as a two-dimensional array or matrix of samples with intensity values (sample values), although of smaller dimension than the picture 17. In other words, the block 203 may comprise, e.g., one sample array (e.g. a luma array in case of a monochrome picture 17, or a luma or chroma array in case of a color picture) or three sample arrays (e.g. a luma and two chroma arrays in case of a color picture 17) or any other number and/or kind of arrays depending on the color format applied. The number of samples in horizontal and vertical direction (or axis) of the block 203 define the size of block 203. Accordingly, a block may, for example, an M×N (M-column by N-row) array of samples, or an M×N array of transform coefficients.

Embodiments of the video encoder 20 as shown in FIG. 14 may be configured to encode the picture 17 block by block, e.g. the encoding and prediction is performed per block 203.

Embodiments of the video encoder 20 as shown in FIG. 14 may be further configured to partition and/or encode the picture using slices (also referred to as video slices), wherein a picture may be partitioned into or encoded using one or more slices (typically non-overlapping), and each slice may comprise one or more blocks (e.g. CTUs) or one or more groups of blocks (e.g. tiles (H.265/HEVC and VVC) or bricks (VVC) used to enable parallel decoding). Applying image segmentation may help reducing the complexity of the processing. In particular, the processing for modification of image may also be performed on a basis of blocks or tiles or any other kind of image portions, irrespectively of whether it is used in a block-based encoder and/or decoder. This enables limiting the network size and make it universal for different image sizes and/or resolutions.

Embodiments of the video encoder 20 as shown in FIG. 14 may be further configured to partition and/or encode the picture using slices/tile groups (also referred to as video tile groups) and/or tiles (also referred to as video tiles), wherein a picture may be partitioned into or encoded using one or more slices/tile groups (typically non-overlapping), and each slice/tile group may comprise, e.g. one or more blocks (e.g. CTUs) or one or more tiles, wherein each tile, e.g. may be of rectangular shape and may comprise one or more blocks (e.g. CTUs), e.g. complete or fractional blocks.

Residual Calculation

The residual calculation unit 204 may be configured to calculate a residual block 205 (also referred to as residual 205) based on the picture block 203 and a prediction block 265 (further details about the prediction block 265 are provided later), e.g. by subtracting sample values of the prediction block 265 from sample values of the picture block 203, sample by sample (pixel by pixel) to obtain the residual block 205 in the sample domain.

Transform

The transform processing unit 206 may be configured to apply a transform, e.g. a discrete cosine transform (DCT) or discrete sine transform (DST), on the sample values of the residual block 205 to obtain transform coefficients 207 in a transform domain. The transform coefficients 207 may also be referred to as transform residual coefficients and represent the residual block 205 in the transform domain.

The transform processing unit 206 may be configured to apply integer approximations of DCT/DST, such as the transforms specified for H.265/HEVC. Compared to an orthogonal DCT transform, such integer approximations are typically scaled by a certain factor. In order to preserve the norm of the residual block which is processed by forward and inverse transforms, additional scaling factors are applied as part of the transform process. The scaling factors are typically chosen based on certain constraints like scaling factors being a power of two for shift operations, bit depth of the transform coefficients, tradeoff between accuracy and implementation costs, etc. Specific scaling factors are, for example, specified for the inverse transform, e.g. by inverse transform processing unit 212 (and the corresponding inverse transform, e.g. by inverse transform processing unit 312 at video decoder 30) and corresponding scaling factors for the forward transform, e.g. by transform processing unit 206, at an encoder 20 may be specified accordingly.

Embodiments of the video encoder 20 (respectively transform processing unit 206) may be configured to output transform parameters, e.g. a type of transform or transforms, e.g. directly or encoded or compressed via the entropy encoding unit 270, so that, e.g., the video decoder 30 may receive and use the transform parameters for decoding.

Quantization

The quantization unit 208 may be configured to quantize the transform coefficients 207 to obtain quantized coefficients 209, e.g. by applying scalar quantization or vector quantization. The quantized coefficients 209 may also be referred to as quantized transform coefficients 209 or quantized residual coefficients 209.

The quantization process may reduce the bit depth associated with some or all of the transform coefficients 207. For example, an n-bit transform coefficient may be rounded down to an m-bit Transform coefficient during quantization, where n is greater than m. The degree of quantization may be modified by adjusting a quantization parameter (QP). For example for scalar quantization, different scaling may be applied to achieve finer or coarser quantization. Smaller quantization step sizes correspond to finer quantization, whereas larger quantization step sizes correspond to coarser quantization. The applicable quantization step size may be indicated by a quantization parameter (QP). The quantization parameter may for example be an index to a predefined set of applicable quantization step sizes. For example, small quantization parameters may correspond to fine quantization (small quantization step sizes) and large quantization parameters may correspond to coarse quantization (large quantization step sizes) or vice versa. The quantization may include division by a quantization step size and a corresponding and/or the inverse dequantization, e.g. by inverse quantization unit 210, may include multiplication by the quantization step size. Embodiments according to some standards, e.g. HEVC, may be configured to use a quantization parameter to determine the quantization step size. Generally, the quantization step size may be calculated based on a quantization parameter using a fixed point approximation of an equation including division. Additional scaling factors may be introduced for quantization and dequantization to restore the norm of the residual block, which might get modified because of the scaling used in the fixed point approximation of the equation for quantization step size and quantization parameter. In one example implementation, the scaling of the inverse transform and dequantization might be combined. Alternatively, customized quantization tables may be used and signaled from an encoder to a decoder, e.g. in a bitstream. The quantization is a lossy operation, wherein the loss increases with increasing quantization step sizes.

Embodiments of the video encoder 20 (respectively quantization unit 208) may be configured to output quantization parameters (QP), e.g. directly or encoded via the entropy encoding unit 270, so that, e.g., the video decoder 30 may receive and apply the quantization parameters for decoding.

Inverse Quantization

The inverse quantization unit 210 is configured to apply the inverse quantization of the quantization unit 208 on the quantized coefficients to obtain dequantized coefficients 211, e.g. by applying the inverse of the quantization scheme applied by the quantization unit 208 based on or using the same quantization step size as the quantization unit 208. The dequantized coefficients 211 may also be referred to as dequantized residual coefficients 211 and correspond—although typically not identical to the transform coefficients due to the loss by quantization—to the transform coefficients 207.

Inverse Transform

The inverse transform processing unit 212 is configured to apply the inverse transform of the transform applied by the transform processing unit 206, e.g. an inverse discrete cosine transform (DCT) or inverse discrete sine transform (DST) or other inverse transforms, to obtain a reconstructed residual block 213 (or corresponding dequantized coefficients 213) in the sample domain. The reconstructed residual block 213 may also be referred to as transform block 213.

Reconstruction

The reconstruction unit 214 (e.g. adder or summer 214) is configured to add the transform block 213 (i.e. reconstructed residual block 213) to the prediction block 265 to obtain a reconstructed block 215 in the sample domain, e.g. by adding—sample by sample—the sample values of the reconstructed residual block 213 and the sample values of the prediction block 265.

Filtering

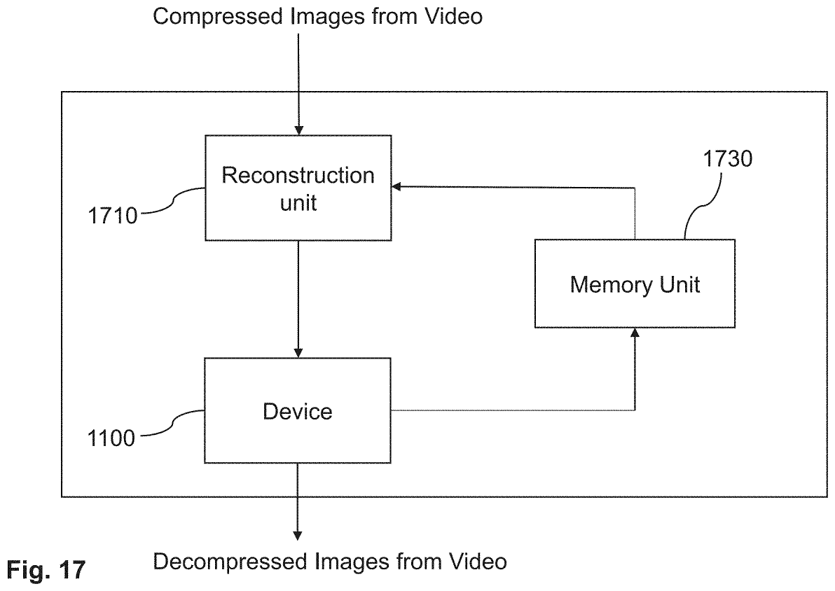

The loop filter unit 220 (or short “loop filter” 220), is configured to filter the reconstructed block 215 to obtain a filtered block 221, or in general, to filter reconstructed samples to obtain filtered sample values. Methods according to the present application may be used in the loop filter. An example for a filter according to the present application that can be used as a loop filter is shown in FIG. 17, with reconstruction unit corresponding to 214, memory unit 1730 corresponding to decoded picture buffer 230, and device 1700 to the loop filter 220. The loop filter unit is, e.g., configured to smooth pixel transitions, or otherwise improve the video quality. The loop filter unit 220 may comprise one or more loop filters such as a de-blocking filter, a sample-adaptive offset (SAO) filter or one or more other filters, e.g. an adaptive loop filter (ALF), a noise suppression filter (NSF), or any combination thereof. In an example, the loop filter unit 220 may comprise a de-blocking filter, a SAO filter and an ALF filter. The order of the filtering process may be the deblocking filter, SAO and ALF. In another example, a process called the luma mapping with chroma scaling (LMCS) (namely, the adaptive in-loop reshaper) is added. This process is performed before deblocking. In another example, the deblocking filter process may be also applied to internal sub-block edges, e.g. affine sub-blocks edges, ATMVP sub-blocks edges, sub-block transform (SBT) edges and intra sub-partition (ISP) edges. Although the loop filter unit 220 is shown in FIG. 14 as being an in loop filter, in other configurations, the loop filter unit 220 may be implemented as a post loop filter. The filtered block 221 may also be referred to as filtered reconstructed block 221.

Embodiments of the video encoder 20 (respectively loop filter unit 220) may be configured to output loop filter parameters (such as SAO filter parameters or ALF filter parameters or LMCS parameters), e.g. directly or encoded via the entropy encoding unit 270, so that, e.g., a decoder 30 may receive and apply the same loop filter parameters or respective loop filters for decoding. Any one of the above mentioned filters of a combination of two or more (or all) of them may be implemented as the image modifying device 1700.

Decoded Picture Buffer

The decoded picture buffer (DPB) 230 may be a memory that stores reference pictures, or in general reference picture data, for encoding video data by video encoder 20. The DPB 230 may be formed by any of a variety of memory devices, such as dynamic random access memory (DRAM), including synchronous DRAM (SDRAM), magnetoresistive RAM (MRAM), resistive RAM (RRAM), or other types of memory devices. The decoded picture buffer (DPB) 230 may be configured to store one or more filtered blocks 221. The decoded picture buffer 230 may be further configured to store other previously filtered blocks, e.g. previously reconstructed and filtered blocks 221, of the same current picture or of different pictures, e.g. previously reconstructed pictures, and may provide complete previously reconstructed, i.e. decoded, pictures (and corresponding reference blocks and samples) and/or a partially reconstructed current picture (and corresponding reference blocks and samples), for example for inter prediction. The decoded picture buffer (DPB) 230 may be also configured to store one or more unfiltered reconstructed blocks 215, or in general unfiltered reconstructed samples, e.g. if the reconstructed block 215 is not filtered by loop filter unit 220, or any other further processed version of the reconstructed blocks or samples.

Mode Selection (Partitioning & Prediction)

The mode selection unit 260 comprises partitioning unit 262, inter-prediction unit 244 and intra-prediction unit 254, and is configured to receive or obtain original picture data, e.g. an original block 203 (current block 203 of the current picture 17), and reconstructed picture data, e.g. filtered and/or unfiltered reconstructed samples or blocks of the same (current) picture and/or from one or a plurality of previously decoded pictures, e.g. from decoded picture buffer 230 or other buffers (e.g. line buffer, not shown). The reconstructed picture data is used as reference picture data for prediction, e.g. inter-prediction or intra-prediction, to obtain a prediction block 265 or predictor 265.

Mode selection unit 260 may be configured to determine or select a partitioning for a current block prediction mode (including no partitioning) and a prediction mode (e.g. an intra or inter prediction mode) and generate a corresponding prediction block 265, which is used for the calculation of the residual block 205 and for the reconstruction of the reconstructed block 215.

The video encoder 20 is configured to determine or select the best or an optimum prediction mode from a set of (e.g. pre-determined) prediction modes. The set of prediction modes may comprise, e.g., intra-prediction modes and/or inter-prediction modes. Terms like “best”, “minimum”, “optimum” etc. in this context do not necessarily refer to an overall “best”, “minimum”, “optimum”, etc. but may also refer to the fulfillment of a termination or selection criterion like a value exceeding or falling below a threshold or other constraints leading potentially to a “sub-optimum selection” but reducing complexity and processing time.

Intra-Prediction

The set of intra-prediction modes may comprise different intra-prediction modes, e.g. non-directional modes like DC (or mean) mode and planar mode, or directional modes, e.g. as defined in HEVC, or may comprise different intra-prediction modes, e.g. non-directional modes like DC (or mean) mode and planar mode, or directional modes, e.g. as defined for VVC. As an example, several conventional angular intra prediction modes are adaptively replaced with wide-angle intra prediction modes for the non-square blocks, e.g. as defined in VVC. As another example, to avoid division operations for DC prediction, only the longer side is used to compute the average for non-square blocks. And, the results of intra prediction of planar mode may be further modified by a position dependent intra prediction combination (PDPC) method.

The intra-prediction unit 254 is configured to use reconstructed samples of neighboring blocks of the same current picture to generate an intra-prediction block 265 according to an intra-prediction mode of the set of intra-prediction modes.

The intra prediction unit 254 (or in general the mode selection unit 260) is further configured to output intra-prediction parameters (or in general information indicative of the selected intra prediction mode for the block) to the entropy encoding unit 270 in form of syntax elements 266 for inclusion into the encoded picture data 21, so that, e.g., the video decoder 30 may receive and use the prediction parameters for decoding.

Inter-Prediction

The set of (or possible) inter-prediction modes depends on the available reference pictures (i.e. previous at least partially decoded pictures, e.g. stored in DBP 230) and other inter-prediction parameters, e.g. whether the whole reference picture or only a part, e.g. a search window area around the area of the current block, of the reference picture is used for searching for a best matching reference block, and/or e.g. whether pixel interpolation is applied, e.g. half/semi-pel, quarter-pel and/or 1/16 pel interpolation, or not.

Additional to the above prediction modes, skip mode, direct mode and/or other inter prediction mode may be applied.

The inter prediction unit 244 may include a motion estimation (ME) unit and a motion compensation (MC) unit (both not shown in FIG. 2). The motion estimation unit may be configured to receive or obtain the picture block 203 (current picture block 203 of the current picture 17) and a decoded picture 231, or at least one or a plurality of previously reconstructed blocks, e.g. reconstructed blocks of one or a plurality of other/different previously decoded pictures 231, for motion estimation. E.g. a video sequence may comprise the current picture and the previously decoded pictures 231, or in other words, the current picture and the previously decoded pictures 231 may be part of or form a sequence of pictures forming a video sequence.

The encoder 20 may, e.g., be configured to select a reference block from a plurality of reference blocks of the same or different pictures of the plurality of other pictures and provide a reference picture (or reference picture index) and/or an offset (spatial offset) between the position (x, y coordinates) of the reference block and the position of the current block as inter prediction parameters to the motion estimation unit. This offset is also called motion vector (MV).

The motion compensation unit is configured to obtain, e.g. receive, an inter prediction parameter and to perform inter prediction based on or using the inter prediction parameter to obtain an inter prediction block 265. Motion compensation, performed by the motion compensation unit, may involve fetching or generating the prediction block based on the motion/block vector determined by motion estimation, possibly performing interpolations to sub-pixel precision. Interpolation filtering may generate additional pixel samples from known pixel samples, thus potentially increasing the number of candidate prediction blocks that may be used to code a picture block. Upon receiving the motion vector for the PU of the current picture block, the motion compensation unit may locate the prediction block to which the motion vector points in one of the reference picture lists.

The motion compensation unit may also generate syntax elements associated with the blocks and video slices for use by video decoder 30 in decoding the picture blocks of the video slice. In addition or as an alternative to slices and respective syntax elements, tile groups and/or tiles and respective syntax elements may be generated or used.

Entropy Coding

The entropy encoding unit 270 is configured to apply, for example, an entropy encoding algorithm or scheme (e.g. a variable length coding (VLC) scheme, an context adaptive VLC scheme (CAVLC), an arithmetic coding scheme, a binarization, a context adaptive binary arithmetic coding (CABAC), syntax-based context-adaptive binary arithmetic coding (SBAC), probability interval partitioning entropy (PIPE) coding or another entropy encoding methodology or technique) or bypass (no compression) on the quantized coefficients 209, inter prediction parameters, intra prediction parameters, loop filter parameters and/or other syntax elements to obtain encoded picture data 21 which can be output via the output 272, e.g. in the form of an encoded bitstream 21, so that, e.g., the video decoder 30 may receive and use the parameters for decoding. The encoded bitstream 21 may be transmitted to video decoder 30, or stored in a memory for later transmission or retrieval by video decoder 30.

Other structural variations of the video encoder 20 can be used to encode the video stream. For example, a non-transform based encoder 20 can quantize the residual signal directly without the transform processing unit 206 for certain blocks or frames. In another implementation, an encoder 20 can have the quantization unit 208 and the inverse quantization unit 210 combined into a single unit.

FIG. 15 shows an example of a video decoder 30 that is configured to implement the techniques of this present application. The video decoder 30 is configured to receive encoded picture data 21 (e.g. encoded bitstream 21), e.g. encoded by encoder 20, to obtain a decoded picture 331. The encoded picture data or bitstream comprises information for decoding the encoded picture data, e.g. data that represents picture blocks of an encoded video slice (and/or tile groups or tiles) and associated syntax elements.

In the example of FIG. 15, the decoder 30 comprises an entropy decoding unit 304, an inverse quantization unit 310, an inverse transform processing unit 312, a reconstruction unit 314 (e.g. a summer 314), a loop filter 320 and a post-processing filter 321, a decoded picture buffer (DBP) 330, a mode application unit 360, an inter prediction unit 344 and an intra prediction unit 354. Inter prediction unit 344 may be or include a motion compensation unit. Video decoder 30 may, in some examples, perform a decoding pass generally reciprocal to the encoding pass described with respect to video encoder 100 from FIG. 14.

Methods according to the present application can be used, for instance, in the loop filter 320 and the post-processing filter 321. FIG. 17 shows an example for a device that can be used as a loop filter 320, as mentioned above with reference to the encoder. An example for a device that can be used as a post-processing filter is shown in FIG. 11.

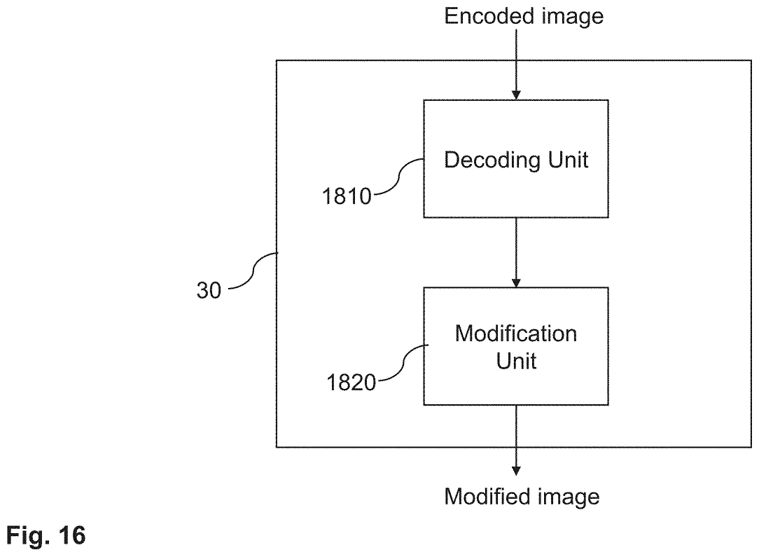

FIG. 16 shows an implementation of a decoder 30 according to an embodiment of the present application. The decoder comprises a decoder unit 1810 configured to decode the encoded image from the bitstream, and a modification unit 1820 configured to modify the decoded image according to the embodiments discussed above.

FIG. 17 shows an implementation of a device for reconstructing compressed images or video frames comprising a reconstruction unit 1710 configured to reconstruct an image using an image prediction based on a reference image stored in a memory, the device 1100 configured to modify the decoded image according to the embodiments described above, and a memory unit 1730 for storing the modified image as a reference image. Such device may be used, for instance,

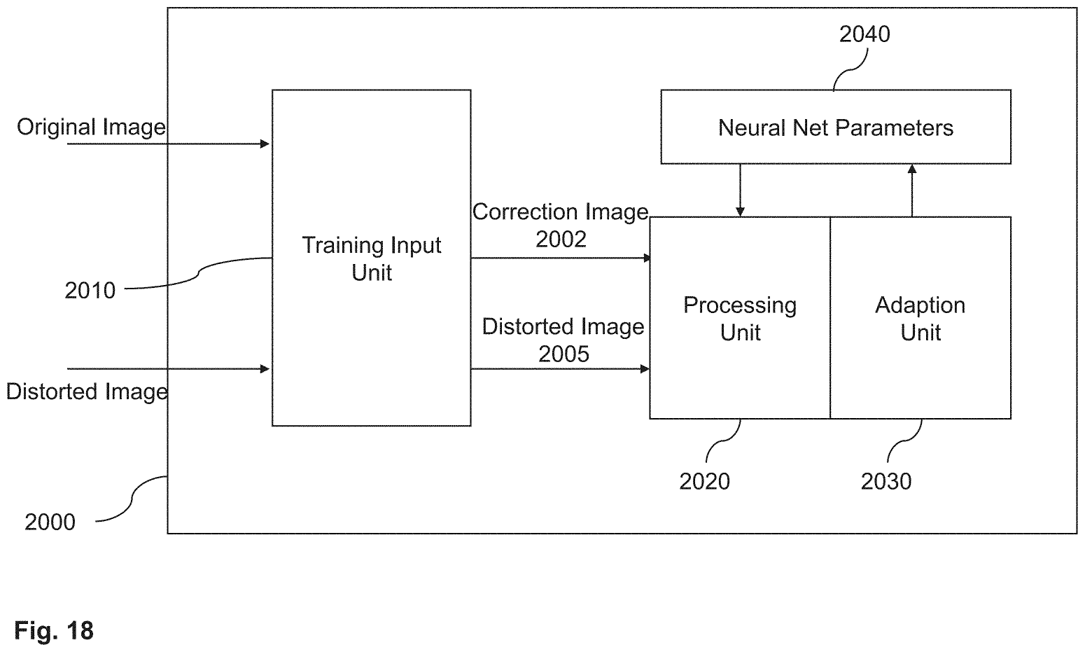

FIG. 18 shows a device 2000 for training a neural network for modifying a distorted image, comprising a training input unit 2010 configured to input to the neural network pairs of a distorted image as a target input and a correction image as a target output, the correction image being obtained based on an original image, a processing unit 2020 configured to process with the neural network, wherein processing with the neural network includes at least one stage including an image down-sampling and a filtering of the down-sampled image; and at least one stage of an image up-sampling, and an adaption unit 2030 configured to adapt at least one parameter 2040 of the filtering based on the inputted pairs. The downsampling is advantageously performed by strided convolution.

FIG. 18 shows the case in which the modification is performed by means of the correction image. However, as mentioned above, the modification may be performed by directly modifying the input image. In such case, the training input unit 2010 may be omitted or merely used to the input to the neural network may be directly the pairs of a distorted image and an original image.

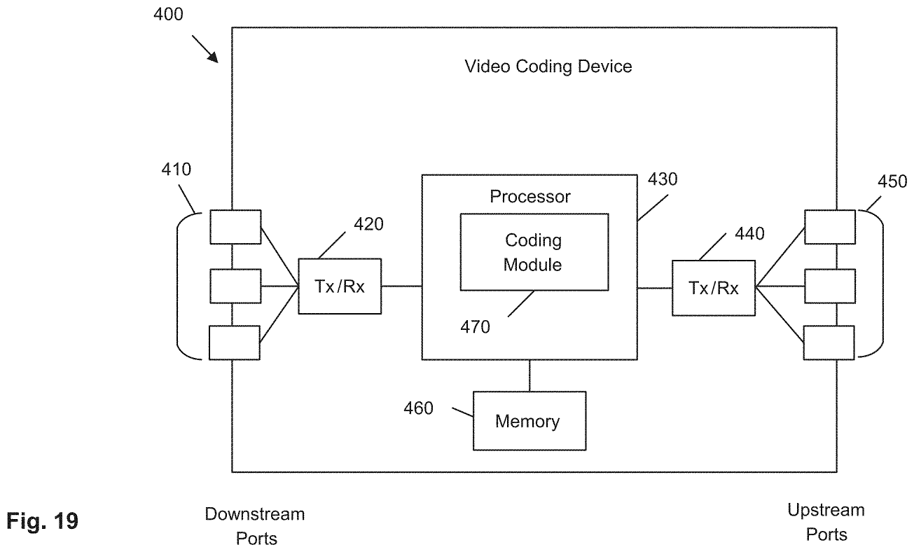

FIG. 19 is a schematic diagram of a video coding device (or in general Image Modification Device) 400 according to an embodiment of the disclosure. The video coding device 400 is suitable for implementing the disclosed embodiments as described herein. In an embodiment, the video coding device 400 may be a decoder such as video decoder 30 of FIG. 14 or an encoder such as video encoder 20 of FIG. 15. In case of a standalone implementation of the image modification as described in the above embodiments, the device 400 may be the Image Modification Device 1100 rather than a video coding device.

The video coding device 400 comprises ingress ports 410 (or input ports 410) and receiver units (Rx) 420 for receiving data; a processor, logic unit, or central processing unit (CPU) 430 to process the data (including the pre-preprocessing of the present application); transmitter units (Tx) 440 and egress ports 450 (or output ports 450) for transmitting the data; and a memory 460 for storing the data. The video coding device 400 may also comprise optical-to-electrical (OE) components and electrical-to-optical (EO) components coupled to the ingress ports 410, the receiver units 420, the transmitter units 440, and the egress ports 450 for egress or ingress of optical or electrical signals.

The processor 430 is implemented by hardware and software. The processor 430 may be implemented as one or more CPU chips, cores (e.g., as a multi-core processor), FPGAs, ASICs, and DSPs. The processor 430 is in communication with the ingress ports 410, receiver units 420, transmitter units 440, egress ports 450, and memory 460. The processor 430 comprises a coding module 470. The coding module 470 implements the disclosed embodiments described above. For instance, the coding module 470 implements, processes, prepares, or provides the various coding operations. The inclusion of the coding module 470 therefore provides a substantial improvement to the functionality of the video coding device 400 and effects a transformation of the video coding device 400 to a different state. Alternatively, the coding module 470 is implemented as instructions stored in the memory 460 and executed by the processor 430.

The memory 460 may comprise one or more disks, tape drives, and solid-state drives and may be used as an over-flow data storage device, to store programs when such programs are selected for execution, and to store instructions and data that are read during program execution. The memory 460 may be, for example, volatile and/or non-volatile and may be a read-only memory (ROM), random access memory (RAM), ternary content-addressable memory (TCAM), and/or static random-access memory (SRAM). The memory module mentioned above may be part of the memory, or may be provided as a separate memory in some implementations.

FIG. 20 is a simplified block diagram of an apparatus 800 that may be used as either or both of the source device 512 and the destination device 514 from FIG. 5 according to an exemplary embodiment. The apparatus 800 may also separately implement the pre-processing 518.

A processor 802 in the apparatus 800 can be a central processing unit. Alternatively, the processor 802 can be any other type of device, or multiple devices, capable of manipulating or processing information now-existing or hereafter developed. Although the disclosed implementations can be practiced with a single processor as shown, e.g., the processor 802, advantages in speed and efficiency can be achieved using more than one processor.

A memory 804 in the apparatus 800 can be a read only memory (ROM) device or a random access memory (RAM) device in an implementation. Any other suitable type of storage device can be used as the memory 804. The memory 804 can include code and data 806 that is accessed by the processor 802 using a bus 812. The memory 804 can further include an operating system 808 and application programs 810, the application programs 810 including at least one program that permits the processor 802 to perform the methods described here. For example, the application programs 810 can include applications 1 through M, which may further include a video postprocessing application, a video decoding or a video encoding application that perform the methods described here.

The apparatus 800 can also include one or more output devices, such as a display 818. The display 818 may be, in one example, a touch sensitive display that combines a display with a touch sensitive element that is operable to sense touch inputs. The display 818 can be coupled to the processor 802 via the bus 812.

Although depicted here as a single bus, the bus 812 of the apparatus 800 can be composed of multiple buses. Further, the secondary storage 814 can be directly coupled to the other components of the apparatus 800 or can be accessed via a network and can comprise a single integrated unit such as a memory card or multiple units such as multiple memory cards. The apparatus 800 can thus be implemented in a wide variety of configurations.

Summarizing, the present disclosure relates to image processing and in particular to modification of an image using a processing such as neural network. The processing is performed to generate an output image. The output image is generated by processing the input image with a neural network. The processing with the neural network includes at least one stage including image down-sampling and filtering of the down-sampled image and at least one stage of image up-sampling. The image down-sampling is performed by applying a strided convolution. An advantage of such approach is increased efficiency of the neural network, which may lead to faster learning and improved performance. The embodiments of the invention provide methods and apparatuses for the processing with a trained neural network, as well as methods and apparatuses for training of such neural network for image modification.

What is claimed is:

1. A method for modifying an input image, wherein the method is applied to a computer device and comprises:
generating an output image by processing the input image with a neural network,
wherein the processing with the neural network includes:
at least one stage including image down-sampling and filtering of the down-sampled image; and
at least one stage of image up-sampling,
wherein the image down-sampling is performed by applying a strided convolution.

2. The method according to claim 1, wherein the strided convolution has a stride of 2.

3. The method according to claim 1, wherein the neural network is based on a U-net, and wherein for establishing the neural network, the U-net is modified by introducing a skip connection to the U-net, the skip connection is adapted to connect the input image with the output image.

4. The method according to claim 1, wherein the neural network is parametrized according to a value of a parameter indicative of an amount or type of distortion of the input image.

5. The method according to claim 1, wherein the activation function of the neural network is a leaky rectified linear unit activation function.

6. The method according to claim 1, wherein the image down-sampling is performed by applying padded convolution.

7. The method according to claim 1, wherein the output image is a correction image, and the method further comprises modifying the input image by combining the input image with the correction image.

8. The method according to claim 7, wherein
the correction image and the input image have the same vertical and horizontal dimensions, and
the correction image is a difference image and the combining the input image with the correction image is performed by addition of the difference image to the input image.

9. A method for reconstructing an encoded image from a bitstream, the method including:
decoding the encoded image from the bitstream, and
applying the method for modifying an input image according to claim 1 with the input image being the decoded image.

10. A method for reconstructing a compressed image of a video, comprising:
reconstructing an image using an image prediction based on a reference image stored in a memory,
applying the method for modifying an input image according to claim 1 with the input image being the reconstructed image, and
storing the modify input image into the memory as a reference image.

11. A method for training a neural network for modifying a distorted image, wherein the method is applied to a computer device and comprises:
inputting, to the neural network, pairs of a distorted image as a target input and a target output image which is based on an original image,
wherein processing with the neural network includes:
at least one stage including an image down-sampling and a filtering of the down-sampled image; and
at least one stage of an image up-sampling,
wherein the image down-sampling is performed by applying a strided convolution; and
adapting at least one parameter of the filtering based on the inputted pairs.

12. The method according to claim 11, wherein the adapting of the at least one parameter of the filtering is based on a loss function corresponding to Mean Squared Error (MSE).

13. The method according to claim 11, wherein the adapting of the at least one parameter of the filtering is based on a loss function including a weighted average of squared errors for more than one color channels.

14. A non-transitory computer-readable medium comprising computer programs which are executed by one or more processors and cause the one or more processors to perform the method according to claim 1.

15. A device for modifying an input image, comprising
a memory coupled to a processor and having computer-executable instructions stored thereon; and
the processor configured to execute the instructions and to generate an output image by processing the input image with a neural network,
wherein the processing with the neural network includes:
at least one stage including image down-sampling and filtering of the down-sampled image; and
at least one stage of image up-sampling,
wherein the image down-sampling is performed by applying a strided convolution.

16. A device for reconstructing an encoded image from a bitstream, comprising:
a decoder configured to decode the encoded image from the bitstream, and
the device configured to modify the decoded image according to claim 15.

17. A device for reconstructing a compressed image of a video, comprising:
an adder configured to reconstruct an image using an image prediction based on a reference image stored in a memory,
the device configured to modify the decoded image according to claim 15, and
a memory storing the modified image as a reference image.

18. A device for training a neural network for modifying a distorted image, comprising:
a training input configured to input to the neural network pairs of a distorted image as a target input and an original image as a target output,
a processor configured to cooperate with the training input to process with the neural network,
wherein processing with the neural network includes:
at least one stage including an image down-sampling and a filtering of the down-sampled image; and
at least one stage of an image up-sampling,
wherein the image down-sampling is performed by applying a strided convolution, and
an adaptor configured to adapt at least one parameter of the filtering based on the inputted pairs.

19. The device according to claim 18, wherein the adapting of the at least one parameter of the filtering is based on a loss function corresponding to Mean Squared Error (MSE).

20. The device according to claim 18, wherein the adapting of the at least one parameter of the filtering is based on a loss function including a weighted average of squared errors for more than one color channels.
